(19) United States
(12) Patent Application Publication
(10) Pub. No.: US 2018/0235383 A1
(43) Pub. Date: Aug. 23, 2018

(54) MODULAR RFID SHELVING

(71) Applicant: Ground Star LLC, Crossville, TN (US)

(72) Inventor: Gary L. Josey, Crossville, TN (US)

(21) Appl. No.: 15/752,040

(22) PCT Filed: Aug. 9, 2016
(86) PCT No.: PCT/US2016/046152

§ 371 Date: Feb. 12, 2018

Related U.S. Application Data
(63) Continuation-in-part of application No. 14/822,466, filed on Aug. 10, 2015, now Pat. No. 9,418,267.
(60) Provisional application No. 62/354,547, filed on Jun. 24, 2016.

(51) Int. Cl. A47F 10/02; A47B 96/02; A47F 5/00; G06K 19/077; B32B 1/02; B32B 7/12; B32B 3/12; B32B 27/06

(52) U.S. Cl. CPC A47F 10/02; A47B 96/021; A47F 5/0043; G06K 19/07773; A47F 2010/005; B32B 7/12; B32B 3/12; B32B 27/065; A47F 2010/025; B32B 1/02

(57) ABSTRACT

A modular smart shelf for use in detecting and reading in real time, via Radio Frequency Identification (RFID), RFID-tagged or labeled articles disposed on or proximate the smart shelf. The smart shelf has a non-metallic low density core layer having opposed top and bottom faces, and an outer perimeter edge, antennae disposed on the top and/or bottom face of the core layer, and a thermoplastic or resinous surface sheet covering the antennae and secured to the top and bottom faces of the core layer. The modular shelf can additionally have a molded frame secured along the outer perimeter of the core layer, an RF transceiver electrically connected to the antennae and secured within a cavity of the rear molded member, and a power and communications connector connecting the RF transceiver with a front video display panel and with power and communications components in a support base of a shelf gondola.

### FIELD OF THE INVENTION

The invention relates to a modular composite smart shelf, and more particularly to a modular composite smart shelf for reading real-time inventory of retail goods displayed thereon.

### BACKGROUND OF THE INVENTION

Grocery shopping was once fairly simple: the customer just requested the necessary item (floor, sugar, eggs) from the shopkeeper, who removed it from his supply. There were no choices for multiple brands, sizes, or flavor varieties of the same item. In the 1940's, metal grocery store shelving was introduced, dramatically changing the grocery business. Now, the grocery business has evolved so customers increasingly provide their own service as the shopkeeper solely operates as a retailer, ultimately de-personalizing the relationship the shopkeeper once had with the customer.

That personal relationship had previously allowed retail grocers to focus on knowing and ordering the products the customers preferred, in the size and configuration they wanted. Armed with that knowledge, retail grocers could monitor product movement and keep fresh inventory arriving and the shelves filled; manage the pricing to take advantage of buying opportunities; and convince the customer to keep buying from him rather than from competitors. Over time, the number of product suppliers and the products they offered multiplied, and the suppliers developed sophisticated advertising programs that shifted the consumers' attention to the products themselves rather than the stores they bought them from. As the retail and grocery industries have more complex and the marketplace has been inundated with more items; flashier advertising and promotions; competing stores, including online retailers; and a more varied customer base, managing the needs of the customer and balancing them against the needs of the store has become increasingly difficult. Store inventory records are becoming less accurate, either costing retailers lost sales because of missing inventory or wasting money on surpluses caused by mistakenly ordering more products for which there is already an adequate supply.

Shelf labels help solve this problem, but they represent a large expense for the retailer in materials, time, labor, and generation of waste. A typical chain retailer makes approximately 10,000 to 12,000 price changes each week, and creating shelf labels to reflect those many changes requires printing paper labels and using staff labor to attach them to the shelves. Mistakes often result during that process, and the number of price changes and shelf-labeling errors are both on the rise. (See, “Two Food Chains Trial RFID-based Electronic Shelf Labels, Claire Swedberg, Mar. 30, 2009, http://www.rfidjournal.com/articles/view?4737, the disclosure of which is incorporated by reference in its entirety). It is common for the shelf label to be different from the cashier's register price, leading to irritated customers and lost time for price checks. Correct item pricing is critical to the success of the business, both in covering costs and keeping customers.

There have been numerous attempts to improve on the constantly replaced paper labels (and their associated waste), with longer-lasting or rewritable plastic labels, or with pricing strips that cover an entire shelf front. Electronically-controlled shelf labeling (ESL) systems are limited to individual, battery-powered shelf attachments, which have several drawbacks, including: being cumbersome in the product display area, becoming easily detached from the shelf, requiring monitoring and battery maintenance by store staff, and not being very eye-catching. As discussed in U.S. Pat. Pub. 2013/0176398 A1, the disclosure of which is incorporated by reference in its entirety, such displays are expensive and susceptible to damage, leading to failure of the display. Moreover, such displays may require independent power supplies which make readjusting the spacing between vertically and horizontally adjacent shelves a difficult task as the power supplies have to be independently rerouted. Accordingly, a need exists for alternative display shelf modules for displaying product information and modular shelving systems incorporating the same. Plastic rewriteable tags have similarly failed to solve this problem because they too require extensive time and cost to maintain while being just as inaccurate as paper labels.

Retailers have attempted to address inventory control and shelf labeling issues for over a decade. In 2003, Walmart issued an ultimatum that all vendors would provide radio-frequency identification (RFID) labeling to individual items to help mitigate the high cost associated with performing manual inventories and the errors associated it. Yet, that effort was largely abandoned because retailers and vendors could not agree who would bear those costs, as well as problems associated with reading RFID tags on metal cans and liquids, particularly when cans, bottles, or containers are stacked together tightly, like on a store shelf.

Retail grocers have largely remained absent from any push into using RFID-based tagging. Although cost to implement RFID is commonly cited, the single largest obstacle to RFID in the grocery environment is the metal shelving on which all inventory is displayed. Traditional metal grocery shelving has not proven to be compatible with the integration of modern communications technology. Transferring RFID information has particularly been ineffective, in spite of attempts to place strategically located antennas and readers on shelf backs or aisle ends, because shelves containing RFID antennas and readers are generally inefficient to install and limit the flexibility of the retailer to relocate such shelves in different locations.

Finally, consumer product manufacturers and retailers alike depend on advertising to attract customers to their location and to inspire them to purchase their product. Advertising is a huge expense, and as technology develops, more venues are open for reaching potential customers. While newspapers, magazines and network TV commercials were once the major advertising media, those venues are losing their prominence in favor of online advertising and social media. Despite the enormous cost of traditional advertising, it is often difficult to measure its effectiveness and whether people bought a product because they saw it on a commercial or billboard. However, one principle is generally held unchallenged: point-of-purchase (POP) advertising is one of the most effective means to generate a customer purchase. POP advertising is based on the behavior of consumers after they have declared themselves as shoppers within the store. It has been shown that 70% of purchase decisions are made in-store and that 68% of shoppers said in-store messages would sway their product purchasing decisions, making it imperative to effectively and efficiently implement POP advertising in retail stores. (See http://www.slideshare.net/slickchickit/finaldeck, the disclosure of which is incorporated by reference in its entirety).

Consequently, both suppliers and retailers constantly attempt to perfect POP advertising. An overview of any grocery store often reveals floor decals in front of a manufacturer's products; hanging signs and banners; automatic coupon dispensers; battery-powered talking videos; temporary focused product displays (with seasonal or item specific focus); and signs on shopping carts, store fronts and parking lot cart corrals. Bombarding the customer in this fashion can be generally confusing, messy, and overwhelming, causing the customer to block it all out, or worse, leave the store entirely. Retailers complain about their stores being taken over by the clutter of manufacturers' advertising. Manufacturers complain that retailers often place the provided advertising in a location remote from the inventory items being promoted. The net result is that no one's interest—the retailer, the manufacturer, or the customer—is ultimately served by the present POP advertising system.

One way to reduce the clutter around POP advertising is to attach audio or video units to existing metal shelves to cycle pre-produced videos locally on a set play schedule. This limits the manufacturer's and/or retailer's ability to modify the advertisement or start it at a unique point in time to take advantage of unscheduled or unforeseen events. To date, there is nothing which allows POP advertising to be provided over a network, via broadband or alternative means, directly to the shelf where purchase decisions are being made.

Furthermore, many stores track customer purchases in order to keep a database of the buying habits of their customers. This is usually accomplished by offering “rewards cards” to their customers to increase customer loyalty. These reward cards (i.e. loyalty cards, club cards, preferred customer cards, etc.) provide the customer with discounts or points for a future purchases in return for personal information. Although these retailers use the personal information to track purchasing habits of their customers, a backend database to compile customer purchases, and analytics software to determine more efficient marketing campaigns and advertising opportunities, the retailers are still limited by present traditional and POP advertising to implement those opportunities in practice.

The problem, then, is multi-faceted: products must be available and displayed; the inventory must be managed accurately; shelves must have correct item and price labels; and advertising must be appropriately managed to accomplish its purpose. Accordingly, there remains a need for a solution that addresses all of these issues simultaneously in a cost-effective and efficient manner.

### SUMMARY OF THE INVENTION

The present invention provides a modular composite smart shelf that is useful in detecting and reading in real time, via Radio Frequency Identification (RFID), RFID-tagged or labeled articles disposed on or proximate to the smart shelf. The modular composite smart shelf includes a) a non-metallic low density core layer having opposed top and bottom faces, and an outer perimeter edge; b) one or more antennae disposed on at least one of the top face and the bottom face of the core layer; and c) a thermoplastic or resinous surface sheet covering the one or more antennae and secured to at least one of the top face and the bottom face of the core layer.

In an aspect of the invention, the one or plurality of antennae are affixed to or embedded within the thermoplastic or resinous surface sheet.

In a further aspect of the invention, the thermoplastic or resinous surface sheet extends along and over the outer perimeter edge of the core layer.

In a further aspect of the invention, the core layer further includes an upper non-planar surface and comprises a three-dimensional structure including a matrix of thermoplastic elements.

The present invention also provides a modular composite smart shelf that includes: a) a non-metallic low density core layer comprises a three-dimensional structure including a matrix of thermoplastic elements, the core layer having an upper non-planar surface and a lower surface, and an outer perimeter edge; b) one or more antennae disposed on at least one of the upper surface and the lower surface of the core layer; and c) a thermoplastic or resinous surface sheet covering the plurality of antennae and secured to the upper non-planar surface of the core layer.

In a further aspect of the invention, the modular composite smart shelf includes a molded frame secured along a portion of the outer perimeter edge of the core layer.

In a further aspect of the invention, a molded frame can include: an elongated rear molded frame member affixed to a rear edge of the core layer, having a cavity with a rear-facing opening along the length; an elongated front molded frame member affixed to a front edge of the core layer; and opposed side molded frame members connecting the rear molded member to the front molded member.

In an aspect of the invention, the modular composite smart shelf further includes an RF transceiver in electrical communication with the one or more antennae. In a further aspect, the RF transceiver can be secured within a cavity of a rear molded member.

In an aspect of the invention, a modular composite smart shelf further includes a power and communications connector. In another aspect, the power and communication connector can be secured within the cavity of the rear molded member, and connected in electronic communication with the transceiver. In a further aspect, the power and communication connector can be secured within the core layer or on a bottom surface of the core layer.

In a further aspect of the invention, the front molded frame member is further defined by a top surface and having a video display panel mounted on the front edge of the shelf.

In a further aspect of the invention, the power and communications connector is additionally connected in electronic communication with the front video display panel. The present invention also provides a modular composite smart shelf comprising: a) a non-metallic low density core having opposed top and bottom faces, and an outer perimeter including a rear edge, a front edge, and opposed side edges, each defined by a corresponding rear face, front face, and opposed side faces; b) a molded frame secured to the outer perimeter of the core including the rear face, the front face, and opposed side faces, the molded frame further including: i) an elongated rear molded frame member affixed to the rear face of the core, having a top surface and a cavity with a rear-facing opening along a length of the elongated rear molded frame member; ii) an elongated front molded frame member affixed to the front face of the core, having a top surface, and the front molded frame member having a separate video display panel mounted on the front edge of the shelf; and iii) opposed side molded frame members connecting the rear molded frame member to the front molded member, each side molded frame member having a top surface, a rear end, a front end, and an underside; c) a thermoplastic or resinous sheet including a top thermoplastic or resinous sheet secured to the top face of the core and a bottom thermoplastic or resinous sheet secured to the bottom face of the core, the thermoplastic or resinous sheet further including a plurality of antennae embedded within at least one of the top sheet and the bottom sheet; d) an RFID transceiver in electrical communication with the plurality of antennae, secured within the cavity of the rear molded frame member; and e) a power and communications connector secured within the cavity of the rear molded frame member, and connected in electronic communication with the RFID transceiver, and with the front video display panel, wherein the modular shelf is operable to be electronically plugged, via the power and communications connector, into a power and signal receptor of a shelving structure comprising a plurality of shelves and immediately function to read RFID tagged goods on the smart shelf.

In a further aspect of the invention, at least one of the opposed side molded frame members has a channel extending from the rear end to the front end, wherein the channel provides a means for providing the electronic communication connection between the power and communications connector and the front video display panel.

In a further aspect of the invention, the front video display panel is mounted to the front molded frame member.

In a further aspect of the invention, the rear molded frame member contains one or more electronic components for communication with or between the microprocessor, the RF transmitter, the front video display panel, and with an electronic device in the shelving structure.

In a further aspect of the invention, a power and communications connector can be secured within the cavity of the rear molded frame member, and can include a plurality of connector blades. The plurality of connector blades can extend rearwardly through the rear-facing opening, configured to engage a power and signal receptacle in an upright support member of a shelving structure. The closure covering the rear-facing opening of the rear molded frame member can have an opening through which the connector blades extend. A hatch covering covers the opening and includes slot openings to accommodate extensions of the connector blades. In a further aspect of the invention, the modular composite smart shelf further includes a closure covering a portion of the rear-facing opening of the rear molded frame member. The closure can be transparent, such as a transparent thermoplastic material.

In a further aspect of the invention, an edge of the thermoplastic or resinous top sheet covers at least a portion of the top surface of the molded frame.

In a further aspect of the invention, the modular composite smart shelf further includes a pair of support brackets, each support bracket configured to attach to one of the opposed side molded frame members. Each support bracket can also include a horizontal ledge for supporting the underside of the side molded frame member, an upper edge for supporting the shoulder in the side molded member, and a means for removably attaching the smart shelf to an upright support member of a shelving structure.

In another aspect of the invention, the pair of support brackets is RF absorbing.

In further aspect of the invention, the molded frame comprises an extruded thermoplastic. The molded frame can also comprise a composite material comprising a thermoplastic resin and a reinforcing filler material.

In an aspect of the invention, the thermoplastic or resinous sheet can be a composite material comprising a thermoplastic or resinous material and a reinforcing filler material.

In another aspect of the invention, a modular composite smart shelf includes a plurality of spaced-apart apertures through the core layer and the thermoplastic or resinous surface sheet, to provide ventilation through the shelf.

In a further aspect of the invention, the plurality of spaced apart apertures pass through the core layer along paths that do not intersect and interrupt a lead of the one or more antennae.

In a further aspect of the invention, a modular composite smart shelf further comprises a plurality of antennae disposed on at least one of the top face and the bottom face of the core layer, each antenna having a plurality of pairs of leads, and a plurality of transceiver connection ends, each transceiver connection end comprising a plurality of pairs of leads of each of the plurality of antennae, whereby each antenna is functionally connected to each of the plurality of transceiver connection ends.

In a further aspect of the invention, the plurality of transceiver connection ends is disposed along at least one edge of the core layer, and preferably along at least two edges of the core layer.

The present invention also provides a modular composite smart shelf comprising: a) a non-metallic low density core layer having opposed top and bottom faces, and an outer perimeter having a side edge; b) a plurality of antennae disposed on at least one of the top face and the bottom face of the core layer, each antenna having a pair of leads; c) a plurality of transceiver connection ends disposed in or extending from a peripheral edge of the shelf, each of the transceiver connection ends disposed laterally from one of the plurality of antennae, where a pair of leads of each of the plurality of antennae connect to each of the plurality of transceiver connection ends; d) a thermoplastic or resinous surface sheet covering the plurality of antennae and secured to at least one of the top face and the bottom face of the core layer; and e) a visible indicia mark or pattern applied upon and along the length of the thermoplastic or resinous sheet, positioned longitudinally between adjacent antennae of the plurality of antennae, to indicate the location along the core layer where a cutting laterally of the shelf avoids cutting through an antenna.

In a further aspect of the invention, the indicia marks or patterns are visible to either the naked or aided eye.

In a further aspect of the invention, a modular composite smart shelf further includes an RF reflective layer disposed between the one or plurality of antennae and a face of the core layer.

In a further aspect of the invention, a core layer includes a plurality of layers of the three-dimensional structure.

In a further aspect of the invention, a core layer includes a reinforced cavity within the structure of the core layer for insertion and securing of an electronic component.

In a further aspect of the invention, a core layer has a straight back edge, and a curved peripheral portion.

In a further aspect of the invention, the thermoplastic or resinous sheet includes a top sheet secured to the top face of the core layer.

In a further aspect of the invention, a core layer comprises a honeycomb core layer made of a thermoplastic.

In a further aspect of the invention, a core layer comprises a three-dimensional structure including a matrix of thermoplastic elements, having a specific density of up to about 0.5.

In a further aspect of the invention, the one or plurality of antennae include a power lead and the core layer has an access port in electrical communication with the power lead for attaching the plurality of antennae to a transmitter or a transceiver.

The present invention also provides a method for making a resilient, low density antennae sheet, comprising the steps of: a) providing an continuous antennae sheet that includes a series of antennae affixed along a length of a continuous thermoplastic or resinous material film; b) providing a length of a sheet of a non-metallic low density core layer; and c) laminating a portion of the continuous antennae sheet to at least one surface of the low density core layer to form the resilient, low density antennae sheet, where one or more of the series of antennae are affixed onto a surface of, or are embedded within, the thermoplastic or resinous material of the continuous antennae sheet.

In a further aspect of the invention, the one or more antennae are embedded within the continuous antennae sheet.

In a further aspect of the invention, the one or more antennae are affixed to the surface of the continuous antennae sheet.

In an aspect of the invention, an antenna is a fractal (or comparable) antenna.

In a further aspect of the invention, the one or more antennae has a connection lead disposed in or extending from a peripheral edge of the sheet.

In a further aspect of the invention, such smart shelves, including the modular composite smart shelves, are useful in and can be configured for use in a wide variety of facilities and venues, including retail stores, hospitals, pharmacies, manufacturing plants, armories, offices, and homes, including as shelving in cabinets and storage pantries, and as refrigerator and freezer shelving.

### BRIEF DESCRIPTION OF THE FIGURES

FIG. 1 shows a top-front perspective view of a smart shelf of the present invention, including a core layer structure, perimeter frame, and a top sheet and a bottom sheet, each including antennae.

FIG. 2 shows a bottom-rear perspective view of the smart shelf.

FIG. 3A shows a sectional view through the smart shelf along line 3A-3A of FIG. 1.

FIG. 3B shows the elements of the smart shelf of FIG. 3A in exploded view.

FIG. 4 shows an alternative embodiment of a smart shelf with a core layer having a plurality of core sub-layers.

FIG. 5 shows a top, rear perspective view of the smart shelf with partial cut-away of the top sheet, rear molded frame member, and side molded frame member, showing the antennae, antenna connectors, and a power and communications connector.

FIG. 6 shows an elevation section view of the rear edge of the smart shelf, along line 6-6 of FIG. 1.

FIG. 7 shows an elevation section view of the side edge of the smart shelf, along line 7-7 of FIG. 1.

FIG. 8A shows an elevation section view of the front edge of the smart shelf, along line 8-8 of FIG. 1.

FIG. 8B shows an alternate embodiment of the front edge of the smart shelf shown in FIG. 8A.

FIG. 9 shows a top-front perspective view of an alternate embodiment of a smart shelf of the present invention having an optional video display panel along the front edge of the smart shelf.

FIG. 10 shows an elevation section view of the front edge of a smart shelf having an optional video display panel, along line 10-10 of FIG. 9.

FIG. 11 shows the smart shelf of FIG. 5 with a rear cover panel over the opening of the rear molded frame member, with the rear cover panel and the power and communications connector pulled away from the rear molded frame member.

FIG. 12 shows an elevation section view through the antennae connectors and power and communications connector, along line 12-12 of FIG. 5.

FIG. 13 shows a front-top perspective view of the smart shelf with the attached support bracket, mounted to an upright support structure of a shelf gondola.

FIG. 14 shows a bottom-rear perspective view of the side-mounting support bracket having a raised projection that engages a hole in the underside of the shelf to restrict sliding of the shelf along the support brackets.

FIG. 15 shows an upper, front view of the side-mounting support bracket of FIG. 14.

FIG. 16 shows a perspective view of the shelf gondola including a pair of upright support structures, a support base, and a vertical wall including RF antennae.

FIG. 17 shows an alternative embodiment of a smart shelf with a core layer having a top antennae sheet and bottom antennae sheet that wrap around the side edges.

FIG. 18 shows an embodiment of the smart shelf having a curved form edge, and another embodiment of the smart shelf having a plurality of venting apertures.

FIG. 19 shows a plan view of the smart shelf having the plurality of venting apertures, illustrating the positioning of the antennae out of alignment with the apertures.

FIG. 20 shows a plan view of another embodiment of a smart shelf having the plurality of antennae, and a plurality of transceiver connection ends, each connected to all of the antennae.

FIGS. 21A and 21B illustrate the smart shelf of FIG. 20 having lateral markings to define cut lines for cutting the smart shelf, where the remaining plurality of transceiver connection ends connected to all of the remaining antennae.

FIGS. 21C and 21D illustrate the smart shelf of FIG. 20 having indicia patterns applied upon and along the length of the smart shelf, to avoid cutting through an antenna.

FIG. 22 illustrates a plan view of another embodiment of a smart shelf having a transceiver connection end formed within an interior portion of the area of the smart shelf, rather than at an end edge.

FIGS. 23A and 23B illustrate alternative smart shelves having a thinner core structure for folding or molding.

FIG. 24 illustrates another embodiment of a smart shelf having a core layer is formed in a non-planar or three-dimensional (“3D”) shape.

FIGS. 25A and 25B each illustrate a process and apparatus for making a continuous antennae sheet useful in forming a smart shelf

FIG. 25C illustrates an apparatus and process for laminating a continuous antennae sheet to a non-metallic low density core layer, for forming the smart shelf structure.

### DETAILED DESCRIPTION OF THE INVENTION

A smart shelf of the present invention provides an integral component for manufacturing, retail grocery, sales or institutional shelving systems.

The shelf can be described as “modular”, in that, given an appropriate width shelving structure (commonly referred to as a gondola), shelves can be removed from one location on the gondola and installed in another location, or can be removed from a location on one gondola and installed in a location on another gondola, and be instantly functional. The shelf can additionally be described as “self-contained” or “plug and play”, in that there are no extra parts, wires, cables or connections required for the shelf to function when placed into an installed position of an appropriate gondola. The shelf can function as a modular element in a telecommunications network, regardless of its position or the items stored thereupon, and can be constructed to avoid any interference with identifying, counting and transmitting information about individual items displayed thereon. A plurality of shelves throughout a facility can communicate to facility management and other outside systems how many of an item is disposed on a shelf or within a facility at any given time, where each item is located, and to enable updating the real-time inventory when an item is removed from the shelf.

The shelf can further provide item information on an optional video panel installed, mounted, or affixed onto a front portion of a shelf, accommodating HD video information, which can include advertising and multi-faceted (rotating data screen) shelf item labels. The shelf can also communicate with the facility personnel or customers via a smart phone, providing location information within the facility or store, product or item information via barcodes, including QR codes, or relevant customer offers, pending items viewed or selected.

The smart shelf can read and transmit radio frequency identification (RFID) item information via authorized computer access to facility or store management, to suppliers, and consumer product manufacturers, and (where software design allows) to a customer, for example, via a smart phone.

Traditional shelving has been constructed of metal, including steel and stainless steel, for rigidity and strength. In many demanding applications where metals have traditionally been used, including aircraft and automobile manufacture, weight to strength ratios and manufacturability (among other factors) are key issues. More importantly, in the context of RFID tagging and reading, metal shelves inhibit and prevent radio signals from penetrating through them.

Conversely, shelves formed out of plastic, such as those described by the present invention, are transparent to RFID transmission. Additionally, the smart shelves can be relatively light weight for their strength and contain within their structures all the electronic devices and connections to enable an authorized computer operator to view all the items or inventory (along with additional information contained on the RFID tag, such as the date of manufacture, production lot, or recall information) on a given shelf at a given time. The smart shelves can additionally be used to locate items that are misplaced or mislaid from their intended location by a computer operator, who can “ping” for a given location, identifying what is on a given shelf, or “ping” for a unique item number, thus locating mislaid items within a network of smart shelves.

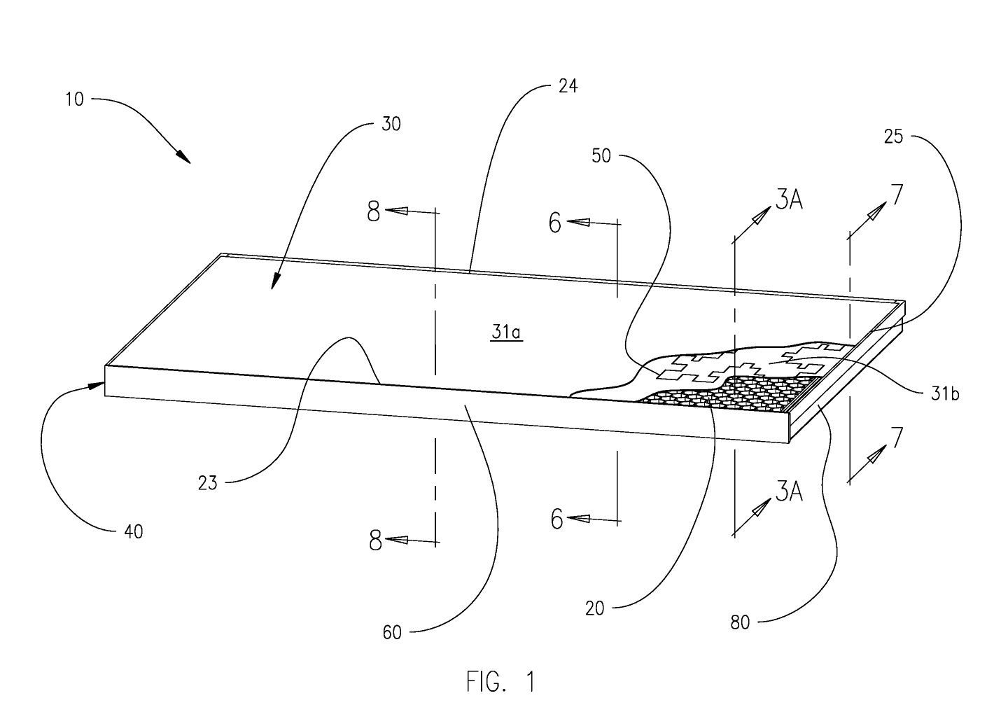

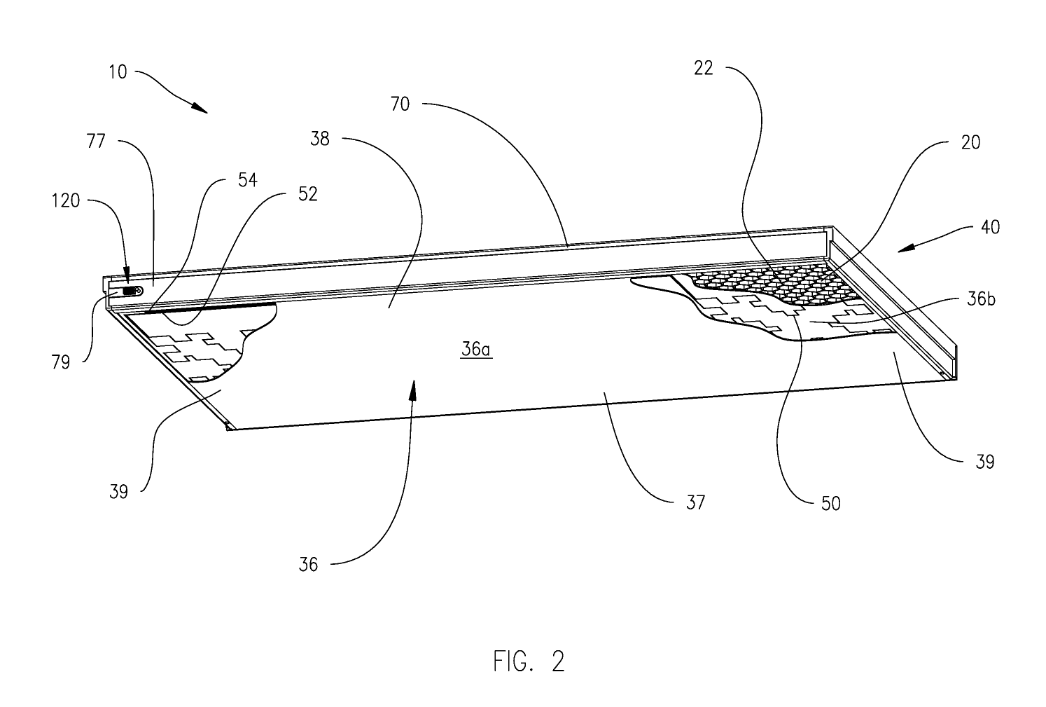

In a first embodiment shown in FIGS. 1 through 3B, a shelf 10 includes a core layer 20, typically in a planar, rectangular shape, a top sheet 30 and bottom sheet 36, and a surrounding perimeter frame 40. The core layer 20 can include a non-metallic, low-density core layer having an opposed top face 21 and bottom face 22, and a continuous outer perimeter including a front edge 23, a rear edge 24; and opposed side edges 25. The low-density core layer 20 has a low basis weight, while having a robust mechanical structure having structural durability (including compression and tensile strength), to maintain a rigid, planar shape under ordinary weight-bearing conditions.

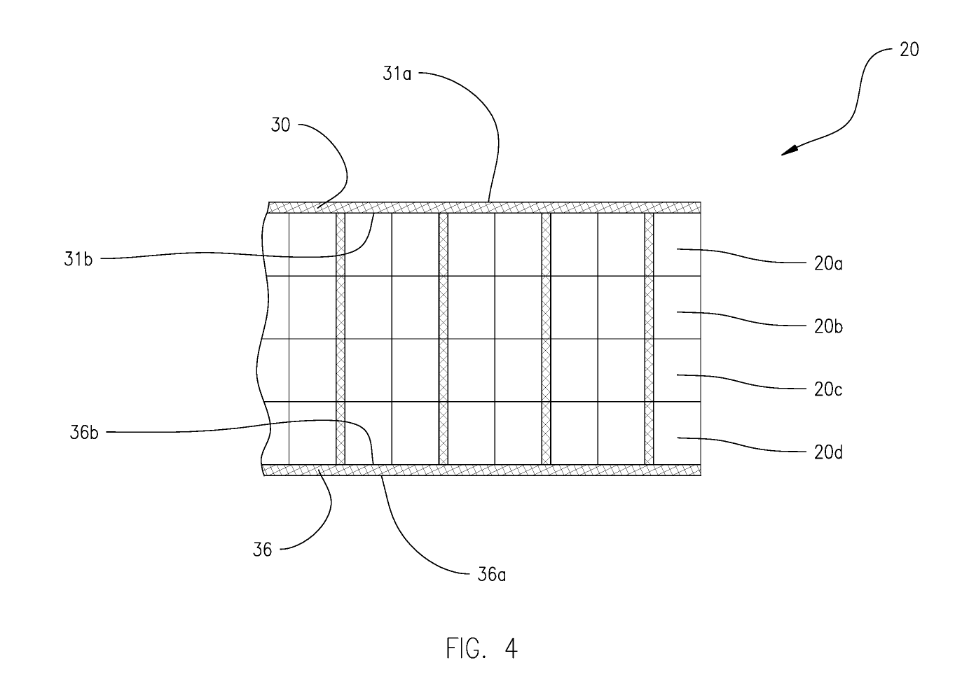

In an alternative embodiment of the invention shown in FIG. 4, the core layer can comprise a plurality of stacked sub-layers 20a through 20d, each sub-layer having a surface interfacing with and secured to the confronting surface of the adjacent sub-layer.

The core layer 20 can be a foamed material, comprising air or gas pockets throughout the structure, or can be a constructed structure made of plastic (including polymers), metallic, cellulosic (including paper and wood), carbonaceous, or inorganic materials. A non-limiting example of a constructed structure is a honeycomb core layer. A typical embodiment of a smart shelf includes a thermoplastic honeycomb core layer, as described in U.S. Pat. No. 5,683,782 (Duchene, 1997). Typical dimensions of the core layer are about 12 inches to 72 inches (30-180 cm) in width, 8 inches to 36 inches (20-90 cm) in shelf depth, and ½ inch to 6 inches (1-15 cm) in thickness, with a honeycomb cell opening size of from about 0.1 inch to about 1 inch (3 to 25 mm). The sidewalls 29 of the honeycomb structures can range from 0.1 mm to 5 mm, and larger, in thickness.

The shelf also includes a thermoplastic or resinous sheet, including a top sheet 30 secured to the top face 21 of the core layer 20, and a bottom sheet 36 secured to the bottom face 22 of the core layer 20, to cover substantially the entire top and bottom surfaces. The sheets 30 and 36 have a thickness of about 1/16 to ¾ inches (1-20 mm), and have a thickness sufficient to provide a firm, flat and even surface to the shelf. The sheets 30 and 36 can comprise a single distinct layer of resin material with the antennae attached or embedded within the layer, or as a laminate in which the antennae are sealed between one or more additional layers of resin material. The material of the thermoplastic or resinous sheet can be selected from the group consisting acrylonitrile butadiene styrene (ABS), polyethylene terephthalate (PET), cellular acetate, ethylene-vinyl acetate, acrylic, epoxy resins, nylon, polyethylene (PE) including high density polyethylene (HDPE) and linear low density polyethylene (LLDPE), polypropylene (PP), polystyrene, polytetrafluoroethylene (PTFE), vinyl, polyvinyl chloride (PVC), polycarbonate, and polyurethane, and laminates and blends thereof. The thermoplastic or resinous sheet can include a composite material comprising a thermoplastic or resinous material and a reinforcing filler material. The sheet can be formed by any well-known process for making sheet pieces or rolls of a sheet.

FIGS. 1, 2 and 5 show that a top sheet 30 or the bottom sheet 36, or both, can include one or a plurality of antennae 50 embedded onto an inwardly-facing surface 31b of the thermoplastic or resinous material of the top sheet 30 or onto an inwardly-facing surface 36b of the bottom sheet 36. Alternatively, one or a plurality of antennae 50 may be fixed within the thermoplastic or resinous material of the sheets 30 and 36, between an outward-facing surface 31a and the inward-facing surface 31b of the top sheet 30, or between an outward-facing surface 36a and the inward-facing surface 36b. In the illustrated embodiment, a plurality of antennae per shelf unit is used. The number of antennae 50 can be sufficient to enable reading of the entire surface area of the shelf. In some embodiments, the shape of an antenna can be a fractal. The size of a typical fractal antenna 50 can range in size from about 1 cm in diameter to several centimeters in diameter (or maximum length); however, in FIGS. 1 through 9, the antennae 50 are shown enlarged for illustration purposes only. The antenna 50 can be laminated within the sheet by various means; for example, as disclosed in U.S. Pat. No. 7,209,039 (Krebs, 2007) and US 2004-0224135 (Krebs), the disclosures of which are incorporated by reference in their entireties. The antennae 50 include RFID antennae, and preferably fractal antennae (e.g. Fractal Antenna Systems, http://www.fractenna.com/index.html), arranged in a matrix pattern. The antennae 50 can be built, inserted or formed into the sheets 30 and 36 during extrusion of the sheets. Each antenna 50 connects through a lead 52 to a connection end 54 disposed in or extending from a peripheral edge of the sheet, typically the rear edge of the sheets 30 and 36, where an electronic contact and interface is made with a plurality of RF transceivers 110. These antennae 50, which may not be viewable and are protected from contact within the top and bottom sheets 30 and 36, enable reading RF and other electronic data on inventory items displayed on the shelf 10, and transmitting the data through the RF or other electronic transceivers (pending tag or ID type encoding) in a rear molded frame member of the shelf, described below.

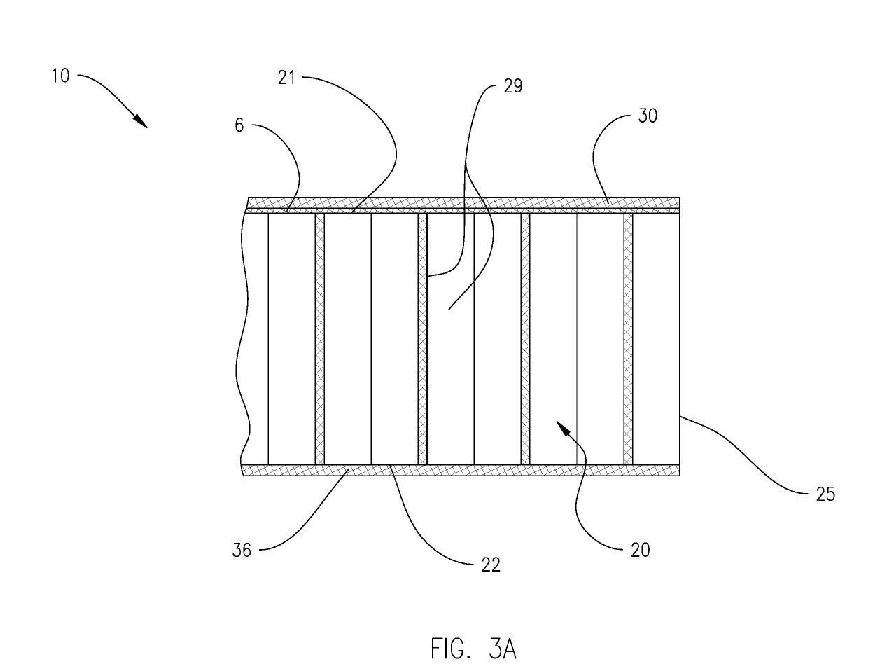

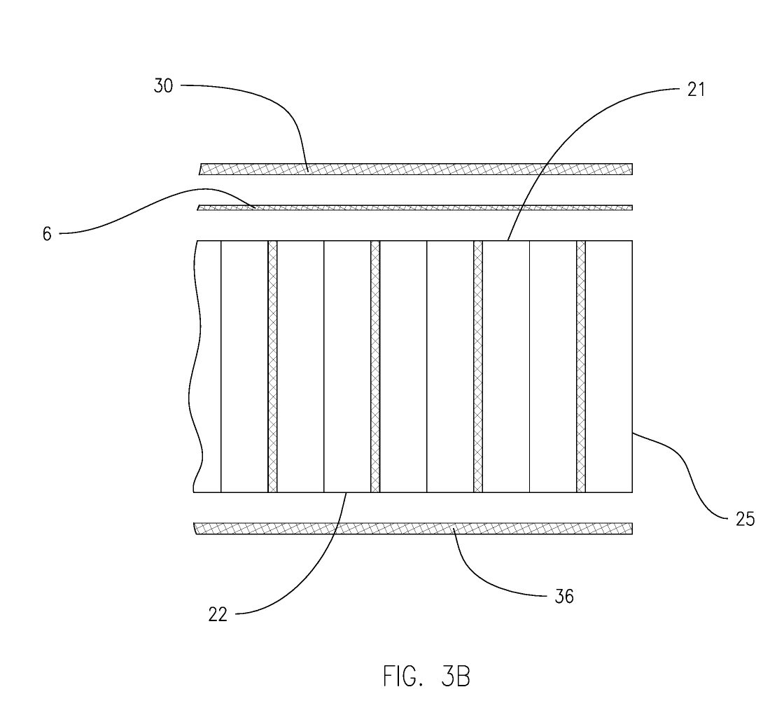

FIG. 3A also illustrates that the smart shelf 10 can include an RF-reflective layer 6 that extends across the upper surface 21 of the core layer 20, and below the top sheet 30 that includes the antennae 50. The RF reflective layer 6 can be made of metals or alloys, and prevents the RF signals emitted by the antennae 50 from passing down through the shelf 10, and prevents any RF signals passing up through the shelf 10 from reaching the antennae 50 of the shelf 10.

The outer perimeter edge of the core layer can be surrounded by a perimeter frame that is typically a molded frame and can include a molded plastic frame. The molded frame 40 is secured along the outer perimeter of the core layer 20. The molded frame 40 includes a front molded frame member 60, a rear molded frame member 70, and opposed side molded frame members 80 that connect the rear molded frame member 70 to the front molded member 60 at opposite ends. The molded plastic frame members can include an extruded thermoplastic frame member. The material of the molded plastic frame members can include a thermoplastic material. The material of the molded plastic frame members can also include a composite material comprising a thermoplastic resin and a reinforcing filler material.

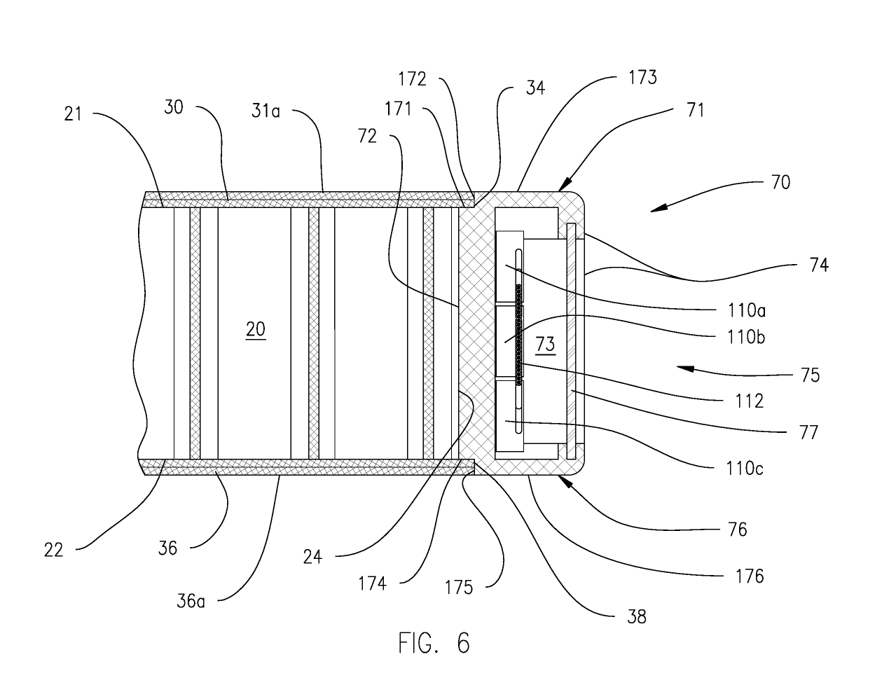

The rear molded frame member 70 (FIG. 6) is an elongated structure extending along and affixed to a face of the rear edge 24 of the core layer 20. The rear molded frame member 70 has a top surface 71, a forward wall 72 has a forward-facing attaching surface that confronts and secures to the rear edge 24 of the core layer 20. The height of the attaching surface of the forward wall 72 can be the same as the thickness of the core layer 20, and the width of the attaching surface 72 can be the same as the length of the rear edge of the core layer 20. The rear molded frame member 70 has a cavity 73 defined at least by the forward wall 72 and the top surface 71, with a rear-facing opening 75 along the rear length. The rear molded frame member 70 can also include a rear-facing surface 74 and a bottom surface 76 to further enclose the cavity 73, with the rear-facing opening 75 disposed in the rear-facing surface 74.

The rear molded frame member 70 can also include a closure 77 that covers the rear-facing opening 75 in the rear molded frame member 70. The closure 77 can be configured for sliding over and away from the opening 75. The closure 77 can be configured with a hinge for pivoting over and away from the opening. The closure can be transparent, and can include, without limitation, a polycarbonate material, a glass material and an acrylic material. The transparent closure 77 protects the electronics within the cavity 73 while allowing accessibility to the electronic components within the rear molded frame member 70, for upgrades, maintenance, repairs, etc.

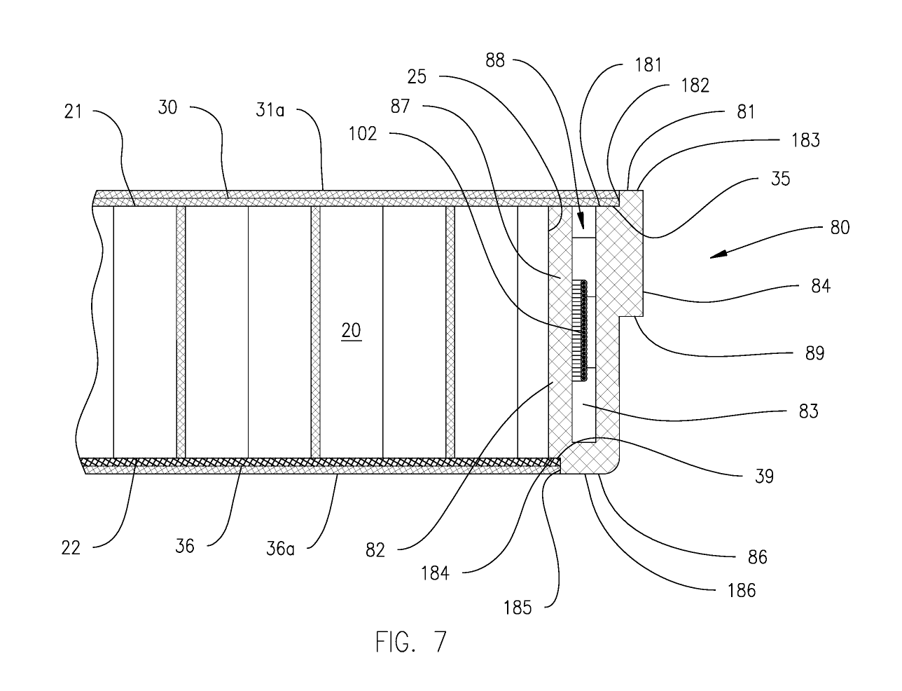

Each opposed side molded frame member 80 (FIG. 7) has a rear end and a front end, a top surface 81, an underside surface 86, an overhanging shoulder 84 defining an undercut 89, and a laterally-facing attaching surface 82 that confronts and secures to a face of each of the opposed side edge 25 of the core layer 20. The height of the attaching surface 82 can be the same as the thickness of the core layer 20, and the width of the attaching surface 82, from the rear end to the front end, can be the same as the width of the side edge of the core layer 20.

One or the other, or both, side molded members 80 has a channel 83 that extends from the rear end to the front end. The channel 83 provides a pathway for extending a wire or cable 102 from the rear of the shelf 10 to the front of the shelf. The channel 83 can be a bore or a slot or groove along the length of the side molded frame member 80. The size or depth of the channel 83 is sufficient for inserting a communication cable or wiring. The channel 83 can be accessed after the side molded members 80 are secured to the side edges 25 of the core layer 20. In an aspect of the invention, the channel 83 is formed into the upper surface 81, for insertion of the communication cable or wiring 102 down through an opening 88 into the channel 83. After the communication cable or wiring 102 is inserted, the opening 88 into the channel 83 can be covered or sealed with a sealant, plug or other covering.

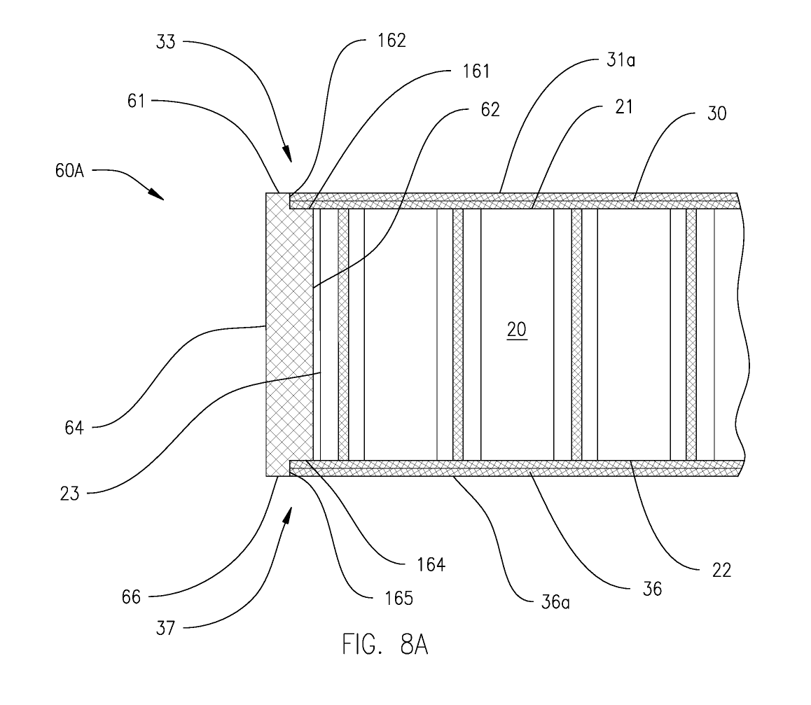

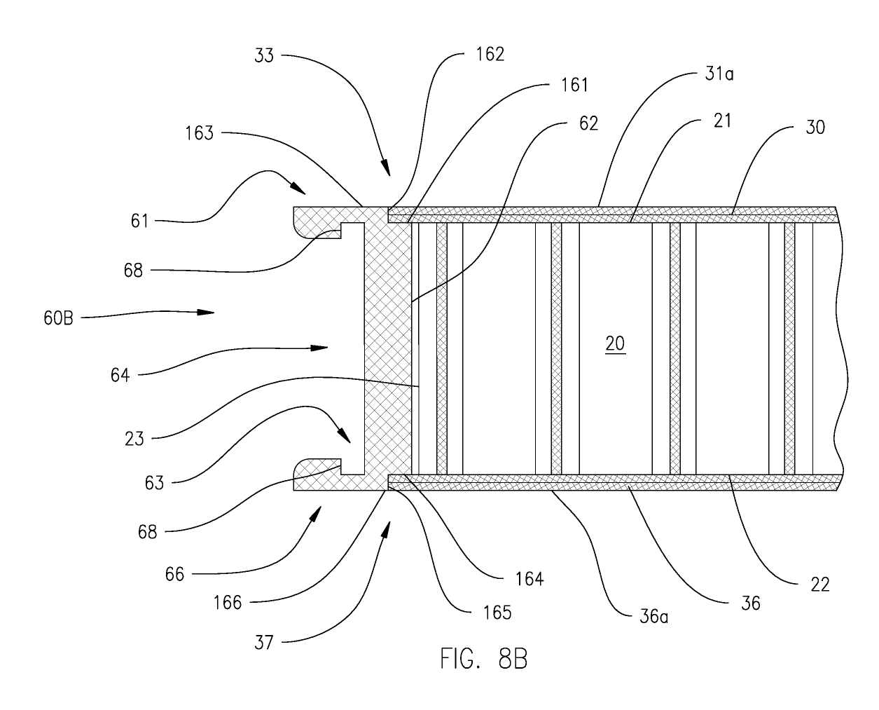

The front molded frame member 60 (FIGS. 8A and 8B) is an elongated structure extending along and affixed to a face of the front edge 23 of the core layer 20. The front molded frame member 60 has a rearward-facing attaching surface 62 that confronts and secures to a face of the front edge 23 of the core layer 20. The height of the attaching surface 62 can be the same as the thickness of the core layer 20, and the width of the attaching surface 62 can be the same as the length of the front edge of the core layer 20. The front molded frame member 60 has a top surface 61, a bottom surface 66, and a forward-facing surface 64. Alternatively, as shown in FIG. 8B, the front molded frame member 60 can additionally include a pair of opposed slots 68 and a cavity 63 for inserting a label.

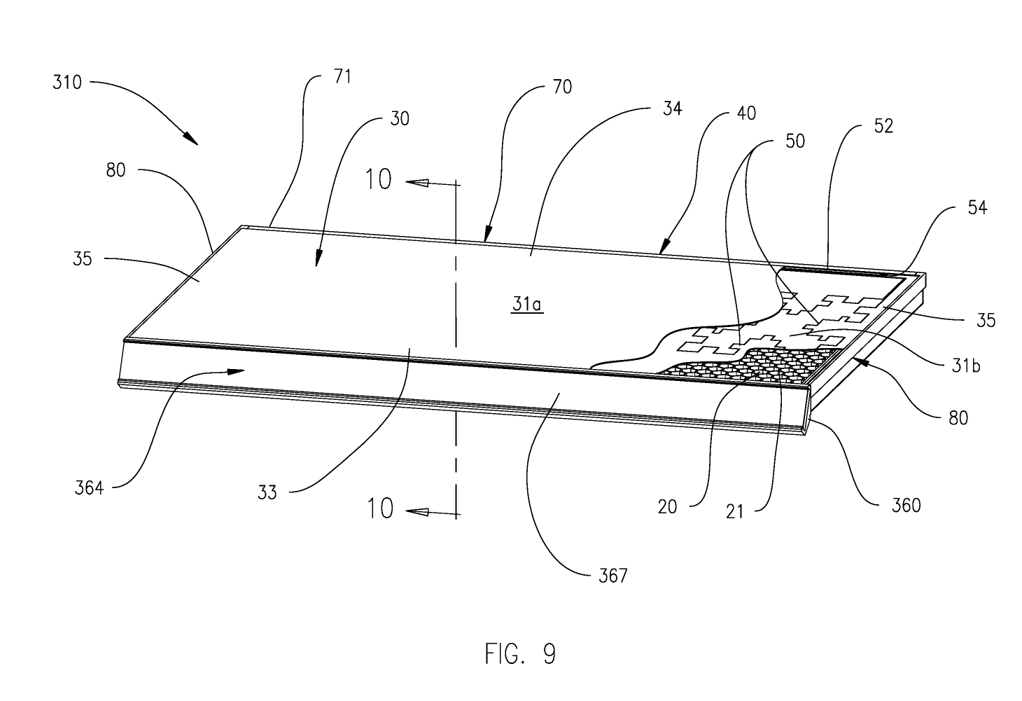

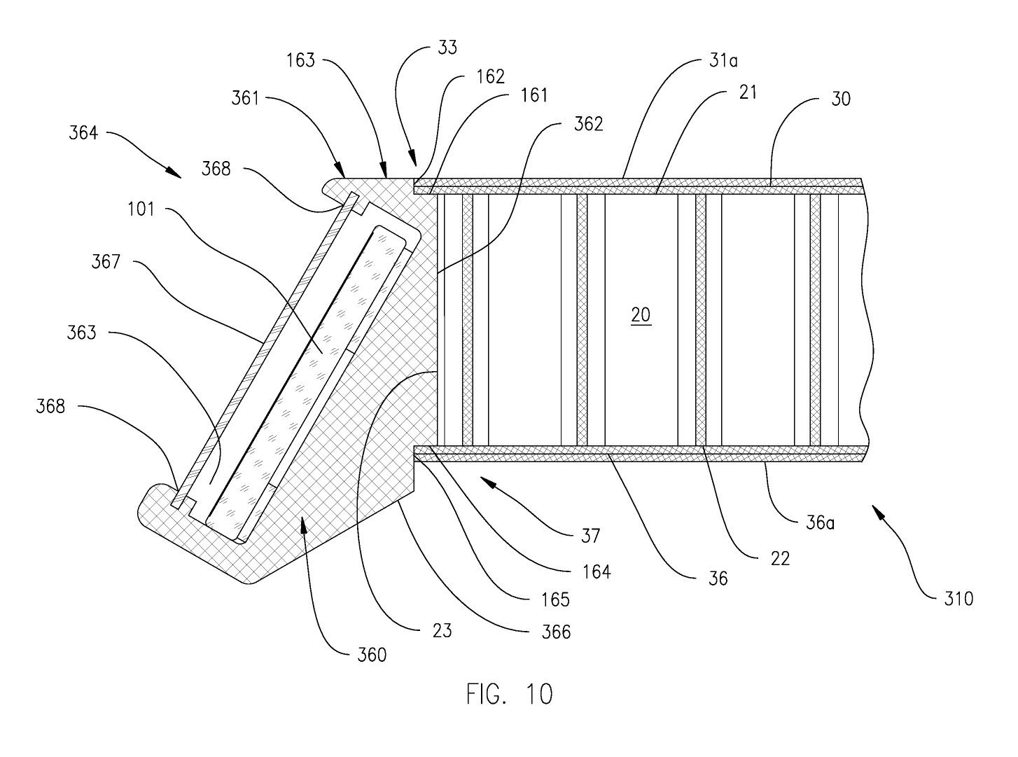

In another alternate embodiment, the forward-facing surface on the front molded frame member can be a forward-facing interface for mounting of an optional video display panel along the front edge of the smart shelf. FIGS. 9 and 10 illustrate a front molded frame member 360 that includes a forward-facing interface 364 on a shelf 310 having a frontward-facing video screen 101. The forward-facing interface 364 includes a forward-facing cavity 363, a pair of opposed slots 368 or other means to hold a clear, transparent protective cover 367. The front molded frame member can be configured to house both a video screen 101 and the protective cover 367. In FIG. 9, the outward-facing surface 31a of the top thermoplastic or resinous surface sheet 30 is partially cut away to reveal the location of the antennae 50 on the inward-facing surface 31b of the top sheet 30. In another embodiment, the front molded frame member can be configured to contain or retain a wireless transceiver (not shown) to communicate item between the transceiver, the facility's item database, and a person's smart phone, tablet, or wearable accessory.

The perimeter edges of the top sheet 30 and bottom sheet 36 can extend over a portion of the top and bottom edges, respectively, of the peripheral frame members. As shown in FIG. 6, the top surface 71 of the rear molded frame member 70 can have an upper landing surface 171, a riser surface 172 extending up from the landing surface 171, in a step fashion, to an upper step surface 173, to receive and secure the rear peripheral edge 34 of the top sheet 30 to the rear molded frame member 70. The rear molded frame member 70 is configured to secure to a face of the rear edge 24 of the core layer so that the upper surface 21 of the core layer 20 is flush with the upper landing surface 171, with the rear peripheral edge 34 of the thermoplastic or resinous sheet 30 extending over the upper landing surface 171 of the rear molded frame member 70. The riser surface 172 is configured in height dimension to the thickness of the thermoplastic or resinous sheet 30, so that the outward-facing surface 31a of the rear peripheral edge 34 of the top sheet 30 is also flush with the upper step surface 173 of the rear molded frame member 70. The under surface of the rear peripheral edge 34 of the top sheet 30 is secured to the upper landing surface 171 of the rear molded frame member 70 to improve the strength and integrity of the shelf unit, while the upward-facing surface 31a of the top sheet 30 extends at a seam to the upper step surface 173 of the rear molded frame member 70.

Likewise, the bottom surface 76 of the rear molded frame member 70 can have a lower landing surface 174, a riser surface 175 extending down from the lower landing surface 174, in a step fashion, to a lower step surface 176. The lower surface 36 of the rear edge 24 of the core layer 20 is flush with the lower landing surface 174, so that the rear edge 38 of the bottom sheet 36 extends over the lower landing surface 174 of the rear molded frame member 70. The lower riser surface 175 is likewise configured in dimension to the thickness of the bottom sheet 36, so that the outward-facing surface 31a of the rear edge 38 of the bottom sheet 36 is also flush with the lower step surface 176 of the rear molded frame member 70. The upper surface of the rear edge 38 of the bottom sheet 36 is secured to the lower landing surface 174 of the rear molded frame member 70 to improve the strength and integrity of the shelf unit.

Similarly, the top surface 61 and bottom surface 66 of the front molded frame member 60 (FIGS. 8A, 8B, and 10) has an upper landing surface 161, a riser surface 162, and an upper step surface 163, to receive and secure the front peripheral edge 33 of the top sheet 30, and a lower landing surface 164 and a riser surface 165, to receive and secure the front peripheral edge 37 of the bottom sheet 36.

Likewise, as shown in FIG. 7, the top surface 81 of the opposed side molded frame members 80 has an upper landing surface 181, a riser surface 182, and an upper step surface 183, to receive and secure the side peripheral edge(s) 35 of the top sheet 30, and the bottom surface 86 has a lower landing surface 184, a riser surface 185, and a lower step surface 186, to receive and secure the side peripheral edge 39 of the bottom sheet 36.

The securing of the peripheral edges of the top sheet 30 and bottom sheet 36 to the upper surfaces of the molded frame 40 and to the upper surface and lower surface of the core layer 20, in combination with the securement of the molded frame 40 to the peripheral edges of the core layer 20, improve the strength and integrity of the shelf unit 10. The top sheet 30 and bottom sheet 36 are secured to the molded frame 40 using an adhesive or thermal bonding. A non-limiting example of an adhesive is a methacrylate. Thermal bonding can be provided by ultrasonic welding, infrared welding, and RF welding.

Within the side molded frame members 80, the channel 83 can be formed into the upper surface 81, down and parallel with the inner wall 87. The construction of the smart shelf permits the installation of the communication cable or wiring 102 into the channel 83, prior to applying the top sheet 30 to the core layer 20. The applied top sheet 30 covers and seals the space within the channel 83 from outside elements, including spills and cleaning solutions. The channel 83 can be formed into the molded frame member 80 when molded or extruded, or can be formed into the molded or extruded frame member 80 using standard machining techniques. The channel 83 can extend a small portion or a substantial portion of the height of the side frame member 80.

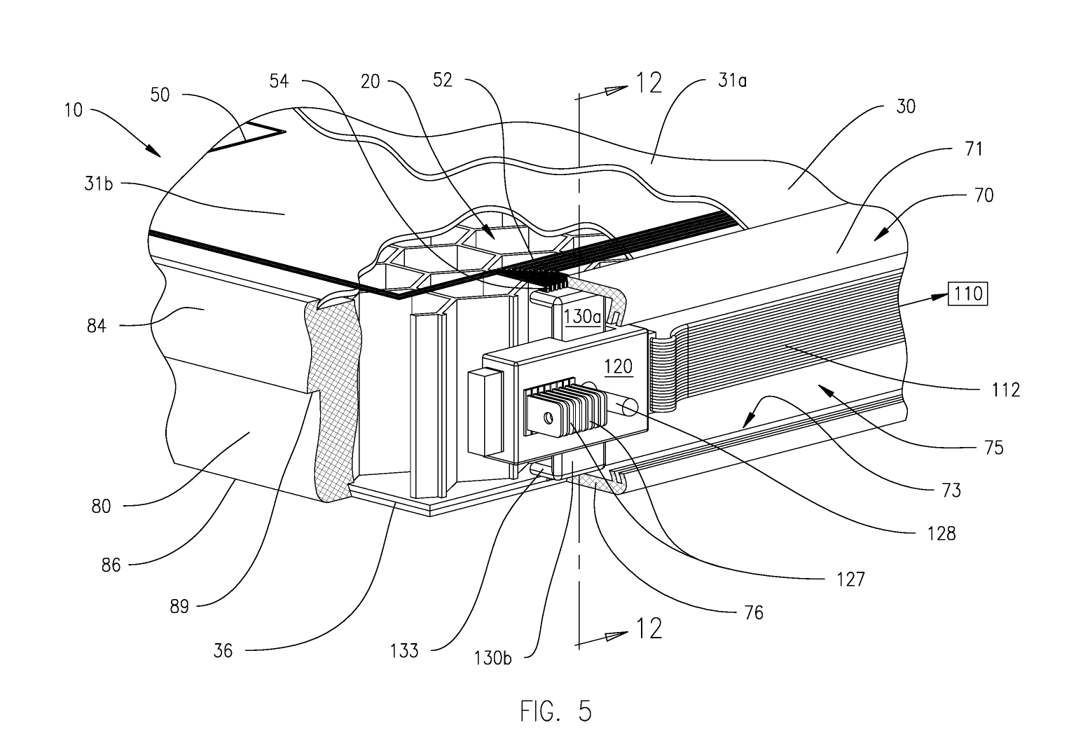

The smart shelf provides electronic components that provide the modular shelf with RFID or other electronic reading and electronic information communication with a local area network. The smart shelf includes one or more RF transceivers (transmitter/receivers) 110 (shown schematically in FIG. 5) secured within the cavity 73 of the rear molded member 70. Each RF transceiver 110 is in electrical communication with a plurality of connection ends 54 of the plurality of antennae 50, as described below. A first RF transceiver 110a is connected to the leads for the plurality of antennae 50 disposed in the top sheet 30, communicating the information from the antennae on and above the top surface of the shelf, and a second RF transceiver 110b is connected to the leads for the plurality of antennae 50 disposed in the bottom sheet 36, communicating the information from the antennae below the bottom surface of the shelf. As depicted in this example, a third RF transceiver 110c can be utilized as a spare.

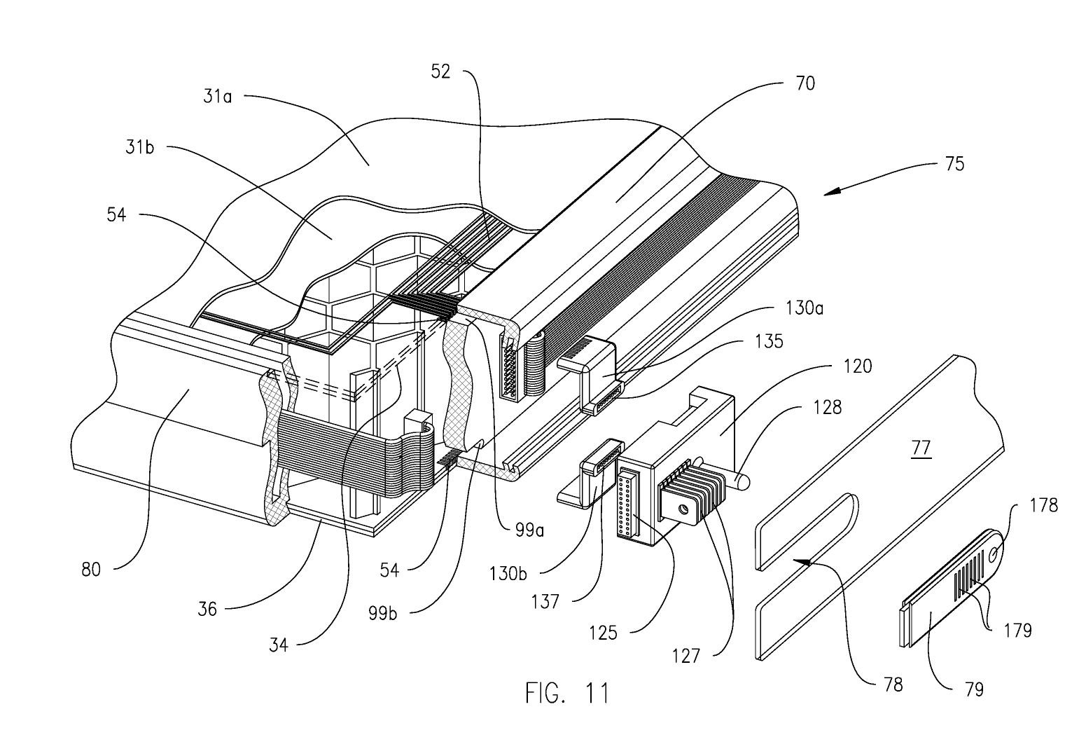

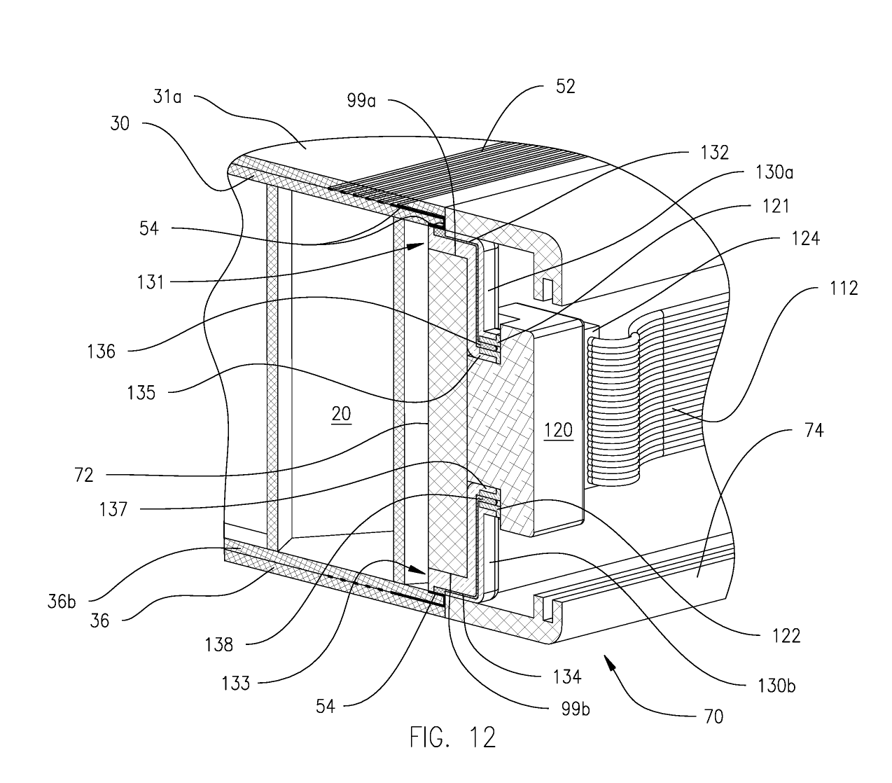

The antennae 50 disposed in the top sheet 30 each connect through a lead 52 to one of a plurality of connection ends 54 that are grouped in spaced-apart series along a portion of the rear edge 34 of the top sheet, that wraps around the rear edge 34 and onto the underside of the top sheet 30, as shown in FIGS. 5, 11, and 12. Likewise, any antennae 50 disposed in the bottom sheet 36 each can connect through a lead 52 to one of a plurality of connection ends 54 grouped in spaced-apart series along a portion of the rear edge 38 of the bottom sheet 36 that wraps around the rear edge 38 and onto the upper side of the bottom sheet 36. An upper antennae connector 130a includes a forward-facing upper port 131 with a set of leads 132 corresponding to and in communication with the corresponding set of connection ends 54 of the upper antennae 50. The upper antennae connector 130a also includes a rearward-facing lower transfer port 135 (FIGS. 11 and 12) having a set of port leads 136 that communicates electrically with the set of leads 132. A lower antennae connector 130b includes a forward-facing lower port 133 with a set of leads 134 corresponding to and in communication with the connection ends 54 of the lower antennae 50. The lower antennae connector 130b also includes a rearward-facing upper transfer port 137 having a set of port leads 138 that communicates electrically with the set of leads 134. The forward-facing upper port 131 and lower port 133 extend through a pair of slot openings 99a and 99b formed through an upper portion and lower portion of the forward wall 72, to secure the upper port 131 and lower port 133 in position. Upper and lower antennae connectors 130a and 130b place the plurality of upper and lower connection ends 54 into electronic communication with a power and communications connector 120, and with the RF transceiver 110 via a multi-lead ribbon cable 112.

The power and communication connector 120 provides a means for making a power and data transmission connection with a power and signal receptacle (data transmission source) in a shelving gondola within a facility, and is configured for delivering power and data transmission communication to and between the electronics and transceivers of the smart shelf, and electronics and network(s) of a shelving gondola and of the store facility. The power and communication connector 120 has a forward facing portion that includes first and second interfaces 121 and 122 (FIG. 12) that receive and provide communication with the first and second transfer ports 135 and 137 of the antennae connectors 130a and 130b. The power and communication connector 120 also includes a first side interface 124 and a second side interface 125. A multi-lead ribbon cable 112 plugs into the side interface 124 and delivers both power, communications and data signals between the power and communication connector 120 and the transceivers 110. The transceivers 110 communicate electronically with corresponding transceivers positioned within the upright supports of the gondola. The transceivers 110 are powered through the multi-lead ribbon cable 112 from the power and communications connector 120, which also powers the antennae 50 through the antennae connectors 130a and 130b. The power and communications connector 120 can also connect with front video display panel 101 via the multi-lead ribbon cable 102 laid through the groove 83 of the side molded frame member 80.

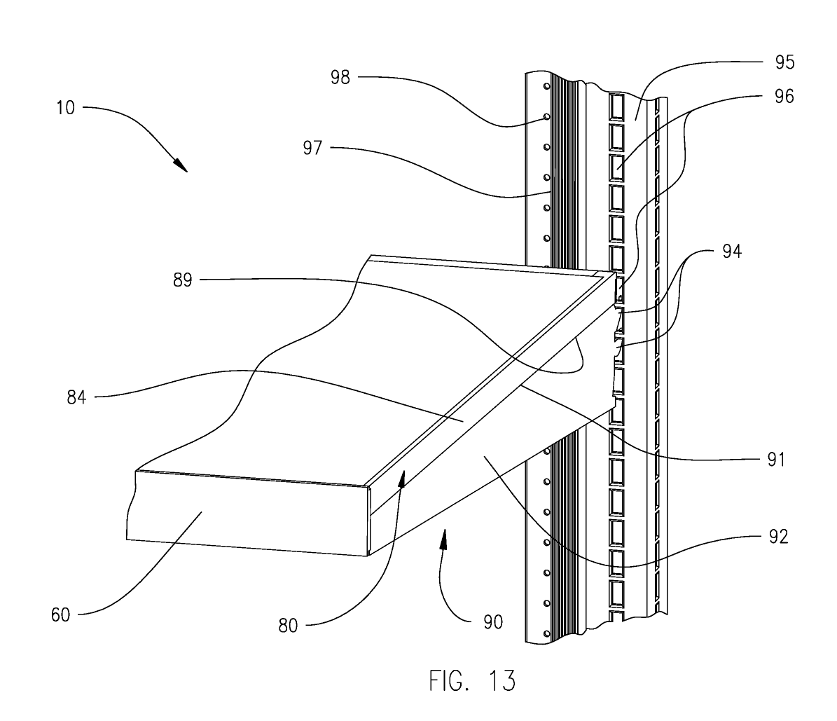

The power and communication connector 120 also includes a plurality of planar, parallel blades 127 extending rearwardly from a back surface. The plurality of blades 127 can include one or more power blades and one or more communication blades. The blades 127 are configured to engage into a corresponding plurality of slots 97 in the upright structure 95 of a gondola (FIG. 13). The plurality of slots 97 include power slots and communication slots corresponding to the power and communication blades 127. The plurality of slots 97 extend vertically from a top end to a bottom end of the upright structure 95, so that the blades 127 engage a corresponding slot 97 regardless of the installation position (height) of the shelf 10 on the upright structure 95. An alignment pin 128 on the power and communication connector 120 engages one of the corresponding plurality of alignment holes 98, adjacent the slots 97, along the height of the upright 95, to ensure proper positioning and installation.

The closure 77 (FIG. 11) can include an opening 78 through which the blades 127 extend. A hatch covering 79 engages the edges of the closure 77 outlining the opening 78, to cover the opening 78. The hatch opening 79 includes slot openings 179 and a hole 178 to accommodate extensions of the blades 127 and the alignment pin 128.

Power to the power and communication connector 120 becomes available once the shelf 10 is installed onto the upright structure 95. Electrical power to the shelf includes low voltage (typically direct current) for the antennae and transceivers, and standard alternating current (AC) for the video panel backlighting and functional requirements.

The smart shelf of the invention provides a modular shelf that can be inserted into, removed from, and repositioned within the upright supports of a shelving gondola, and be instantly functional. The smart shelf is connected to upright supports of the gondola with side-mounting support brackets. The side-mounting support brackets are made of metal, typically stainless steel, and can be treated with an RF absorbing (or masking) material, to eliminate RFID reflections.

The side-mounting brackets can be attached to and support the smart shelf along the side molded frame members 80. As shown in FIG. 13, the side molded frame members 80 include an overhanging shoulder 84 that defines an undercut 89. The side-mounting bracket 90 includes an upright wall 92 that confronts the lower part of the side molded frame member 80, and has an upper edge 91 that supports the undercut surface 89 of the side molded frame member 80. A lower, inwardly-extending horizontal ledge 91 engages and supports the underside 86 of the side molded frame member 80. Preferably, the lower edge of the outer surface of the side molded frame member 80 is rounded to confront a rounded transition between the upright wall 92 and the inwardly-extending horizontal ledge 91 of the side molded frame member 80, to provide adequate support for the side edges of the shelf 10.

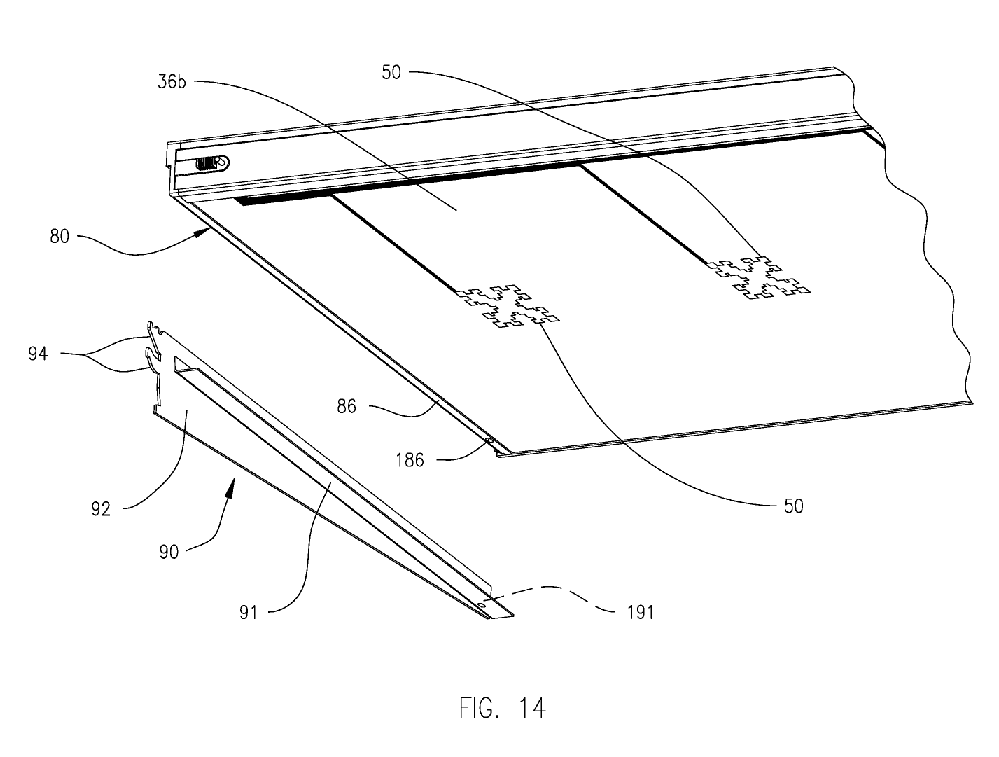

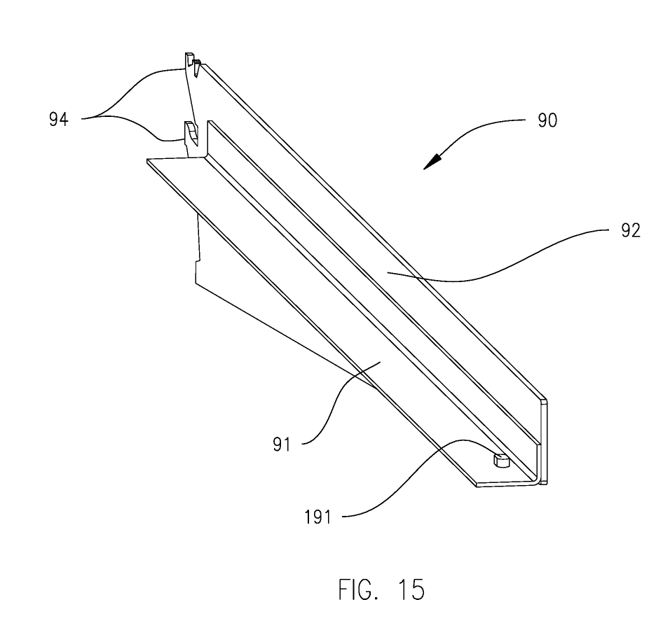

FIGS. 14 and 15 show an extended (raised) projection 191 in the upper surface of the inwardly-extending horizontal ledge 91 that engages and registers inside, to a similarly-sized and -shaped hole 186 in the underside 86 of the side molded frame member 80 ensure a precise locating, and properly tight and secure fitment of the shelf 10 onto the support brackets 90, and to prevent the shelf 10 from sliding along the length of the support bracket 90. Alternatively, the extended (downward) projection can be disposed in the underside of the side molded frame member, and the hole formed into the inwardly-extending horizontal ledge. Other means for engaging the shelf with the support brackets to restrict sliding movement can be used. The specific location of the raised projection 191 along the longitudinal dimension of the horizontal ledge 91 of a particular support bracket can be tailored for a corresponding particular shelf 10 having the corresponding specific location of the hole 186 in the underside 86 of the side molded frame member 80, so that each shelf is properly matched with a support bracket of the proper and sufficient design and reinforcement (gauge and fabrication). In FIG. 14, the outward-facing surface 36a of the bottom thermoplastic or resinous surface sheet 30 is removed to reveal the location of the antennae 50 on the inward-facing surface 36b of the bottom sheet 30.

The side-mounting support brackets 90 also include a means for removably attaching the smart shelf 10 to an upright support member 95 of a shelving structure. The back portion of the support brackets include tabs 94, similar to conventional bracket tabs, which engage and lock within lock openings 96 in the upright supports 95 for mounting the shelf 10 to the shelving gondola. The support bracket and tabs can be configured in a variety of positions, including positioning the shelf surface horizontally, or at one or more angles. The metal support brackets 90 are made of metal of sufficient thickness (7 gauge or thicker) for strength and rigidity, and can be made from a single part or two parts welded together.

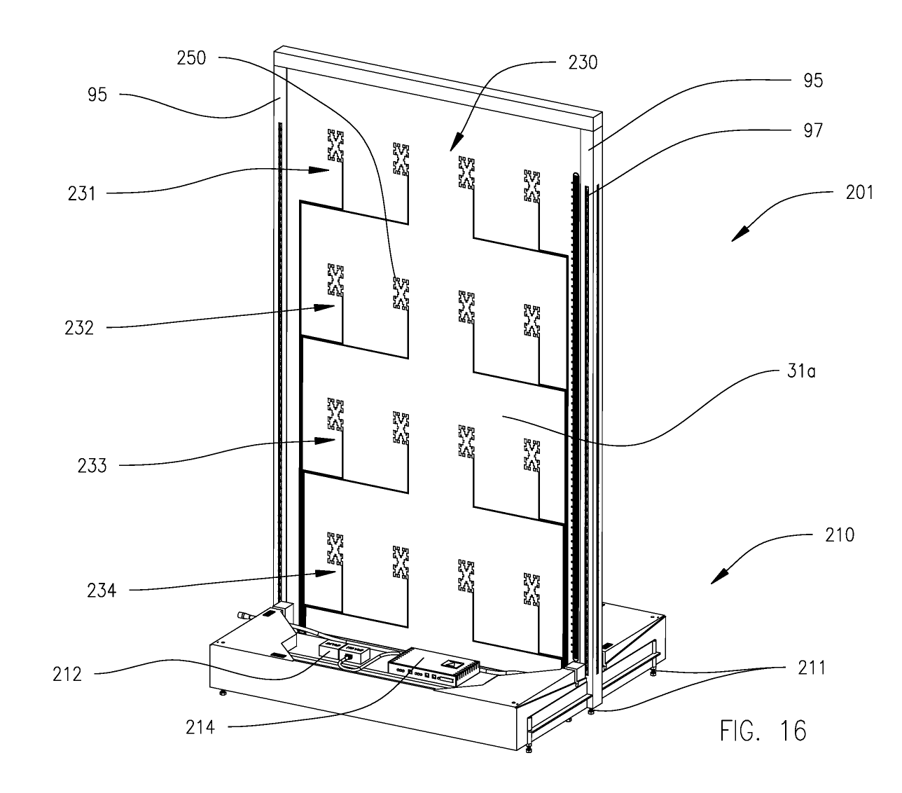

FIG. 16 shows a perspective view of a shelf gondola 201 including a pair of upright support structures 95, a support base 210, and a vertical wall 230 including RF antennae 250. The vertical wall 230 can comprise one or more panels. In the illustrated embodiment, the vertical wall 230 includes four sub-panels 231, 232, 233, and 234, each having a plurality of RF antennae 250 fixed in the sub-panel surfaces. In FIG. 16, the outward-facing surface 31a of the thermoplastic or resinous surface sheet is removed to reveal the location of the antennae 250 on vertical wall 230. An opposed vertical wall can be included on the opposite side of the vertical wall 230. The pair of upright support structures 95 is secured into a support base 210. The support base 210 can include as plurality of leveling supports 211 and/or rollers (not shown) for stabilizing and leveling the support base 210 in a use position, or moving the support base 210 to a use position. The support base also includes power components 212 for providing power to the vertical wall(s) 210 and to the smart shelves, via the power slots among the power and communication slots 97 in the upright support structures 95. Main power is delivered to the support base 210 from receptacles in the store. The support base 210 also includes communication components 214 for providing communications signals to and from the electrical components of the smart shelves, also via communication slots among the power and communication slots 97 in the upright support structures 95. Such communication components include the RF antennae 50, 250, the video display panel 101, the transceivers 110, a network interface for connecting the gondola to a local network, for both sending and receiving signals.

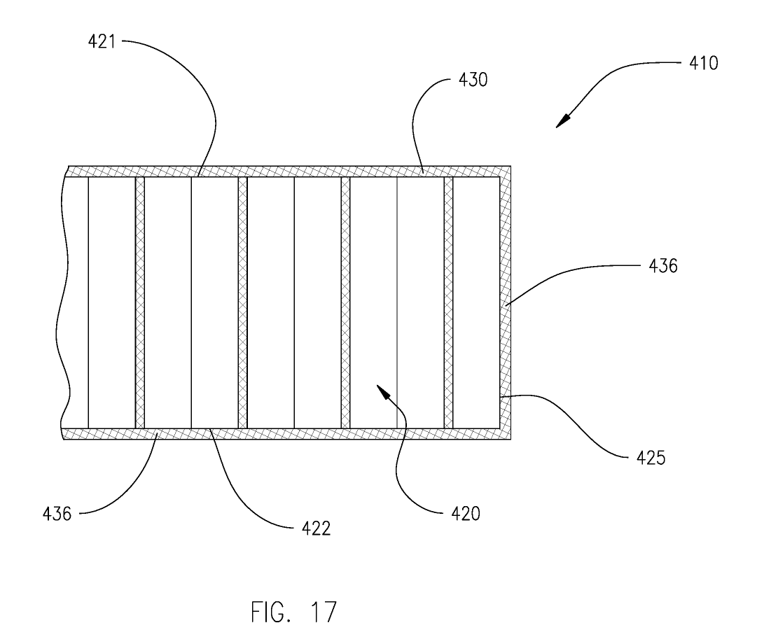

FIG. 17 shows an alternative embodiment of a smart shelf 410 comprising a non-metallic low density core layer 420 having opposed top face 421 and bottom face 422, and an outer perimeter edge, including a side edge 425, where a top portion 430 of the thermoplastic or resinous surface sheet covers the plurality of antennae and is secured to the top face 421, a bottom portion 436 that covers bottom face 422 of the core layer 420, and lateral portion 436 that extends over and along the outer perimeter edge 425 of the core layer 420, to enclose entirely the front, rear and opposed side peripheral edges 425 of the core layer 420.

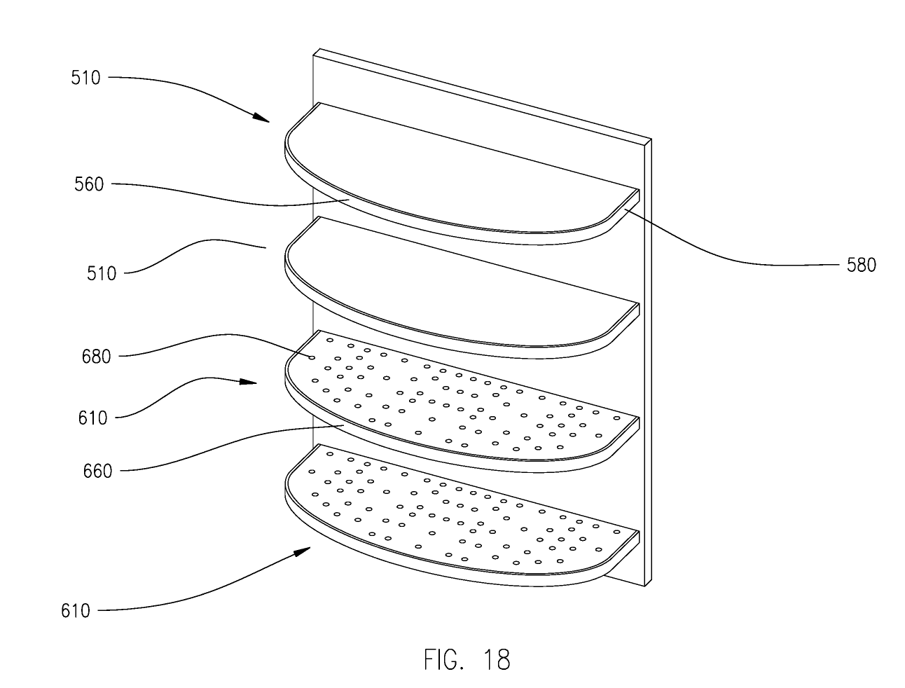

FIG. 18 shows another alternative embodiment of a smart shelf 510 wherein the foot-print shape of the shelf 510 is non-rectangular, and in particular includes an outwardly-curved front edge 560. The side edge 580 can be linear, curved, or both. The perimeter edge of the shelf can include a molded member, or can be a portion of the top sheet or bottom sheet that wraps around and is secured to the side edge, as shown in FIG. 17. The shelf can be any of the smart shelf structures described herein.

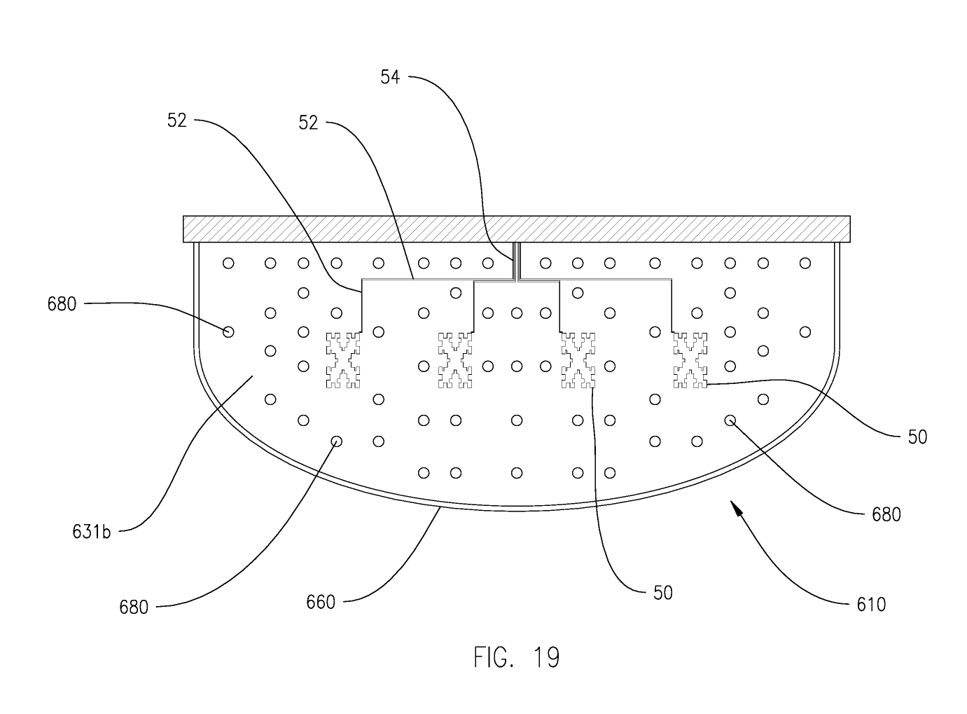

FIG. 18 also shows another embodiment of a modular composite smart shelf 610 where the shelf has a plurality of spaced-apart apertures 680 through the top face 631 and the core layer and the thermoplastic or resinous surface sheet, to provide ventilation through the shelf 610. The number of apertures can be sufficient to provide ventilation through the entire area of the shelf. The shape of the aperture can be circular, oval, polygonal, or any irregular shape. The size of the apertures can be any desired size suitable for effecting ventilation. For small items or objects disposed on the shelf, the size of the apertures may be limited to prevent the small items falling through an aperture. An aperture should be placed through the shelf along a path that does not intersect, cut or interrupt a wire or a lead of one of the plurality of antennae, as shown in FIG. 19, where the outward-facing surface of the thermoplastic or resinous surface sheet has been removed to reveal the location of the antennae 50, leads 52 and transceiver connection end 54.

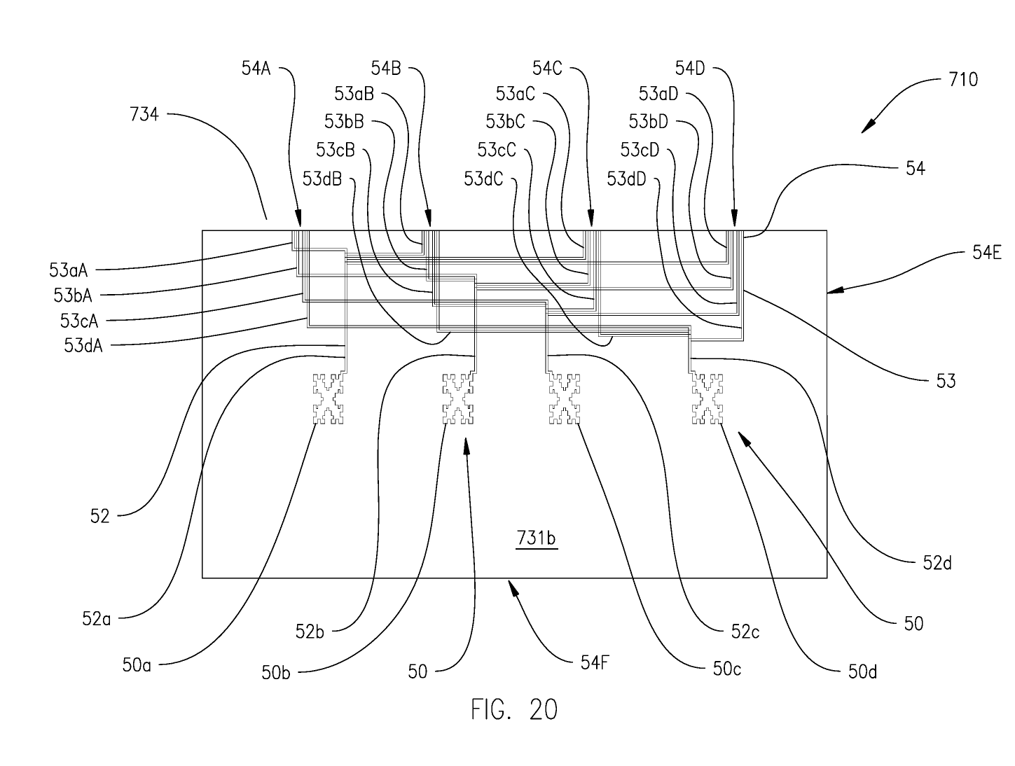

FIG. 20 shows a schematic plan view of yet another embodiment of a smart shelf 710 comprising the non-metallic low density core layer having a top surface 731 and a opposed bottom faces, and an outer perimeter having a peripheral edge, particularly a rear edge 734, a plurality of antennae 50 disposed on the top face of the core layer, and alternatively or additionally on the bottom face of the core layer, and a thermoplastic or resinous surface sheet covering the plurality of antennae. The outward-facing surface of the thermoplastic or resinous surface sheet has been removed to reveal the location of the antennae 50, the wire leads 52 and 53, and transceiver connection ends 54 on the inward-facing surface 731b of the thermoplastic or resinous surface sheet. Each of the plurality of antennae 50 in the shelf includes a pair of electrical leads 52. The shelf also includes a plurality of transceiver connection ends 54, each transceiver connection end 54 consisting of the pair of electrical leads for each of the plurality of antennae 50.

In the illustrated embodiment, the shelf 710 has four antennae, labeled 50a, 50b, 50c, and 50d. The four antennae 50a-50d are placed spaced-apart along the length of the shelf, substantially within four equally-sized segment areas of the shelf 710. The shelf 710 includes four transceiver connection ends 54, labeled 54A, 54B, 54C and 54D. In the illustrated embodiment, leads 52 of each of the four antennae 50 are connected electrically to each of the four transceiver connection ends 54, via branching leads 53. Leads 52a of the first antenna 50 branch and connect electrically to the first transceiver connection end 54 and position 54A via branch leads 53aA, 53bA, 53cA and 53dA. Likewise, leads each of the four antennae 50 also branch and are connected electrically to the second transceiver connection end 54 at position 54B, via branching leads 53aB, 53bB, 53cB and 53dB; leads 52 of each of the four antennae 50 also branch and are connected electrically to the third transceiver connection end 54 at position 54C, via branching leads 53aC, 53bC, 53cC and 53dC; and leads 52 of each of the four antennae 50 also branch and are connected electrically to the fourth transceiver connection end 54 at position 54B, via branching leads 53aD, 53bD, 53cD and 53dD. Overlapping leads 52 and branching leads 53 are configured and manufactured to avoid electrical connectivity between one another by either insulating the leads and the branching leads, or by placing a layer of an electrical insulating material between overlapping leads and branching leads.

In an alternative embodiment of the invention, the tracings of the leads 52 can also be connected to a transceiver connection end disposed along the side perimeter edges of the smart shelf 710 at a position 54E, or even to a transceiver connection end disposed at a position 54F disposed along the front perimeter edge of the smart shelf 710.

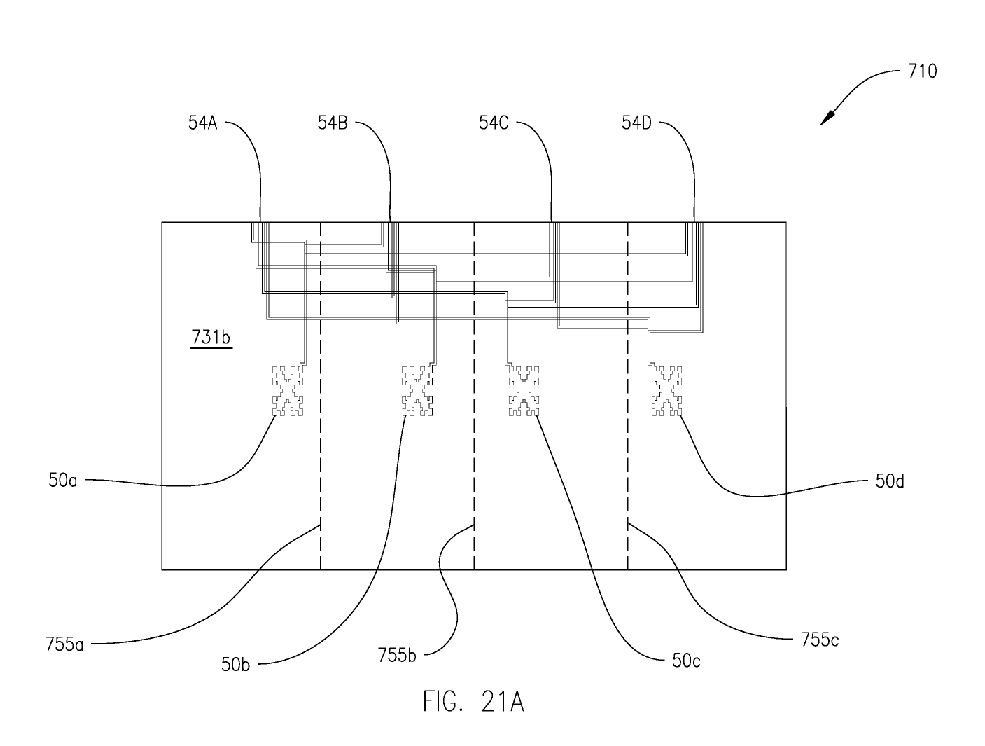

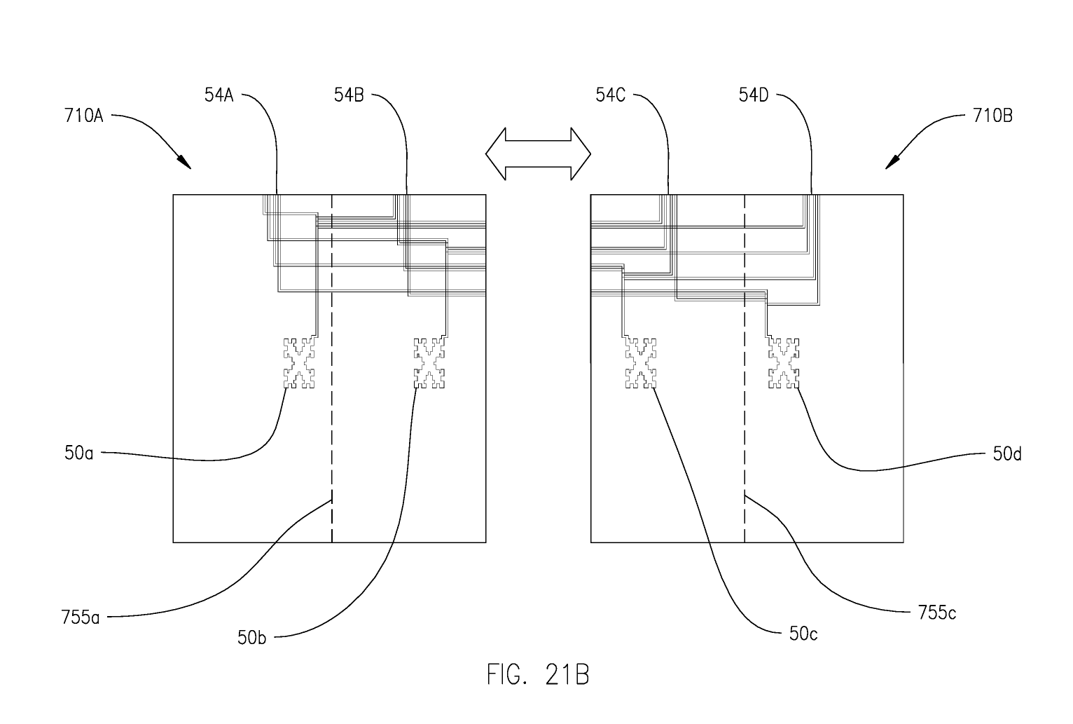

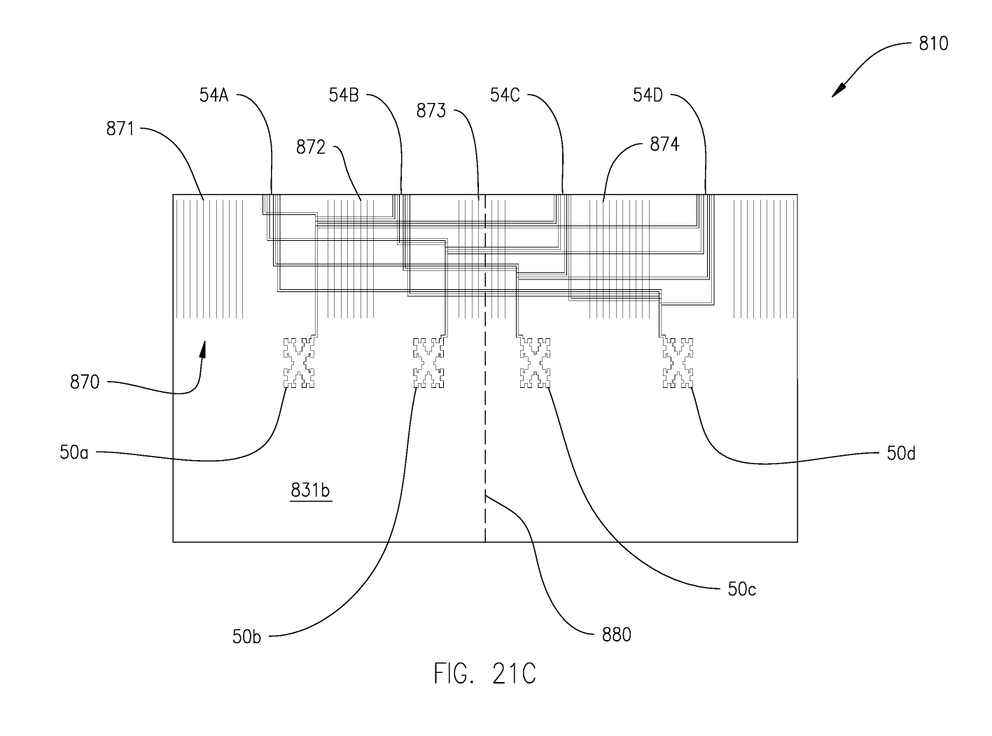

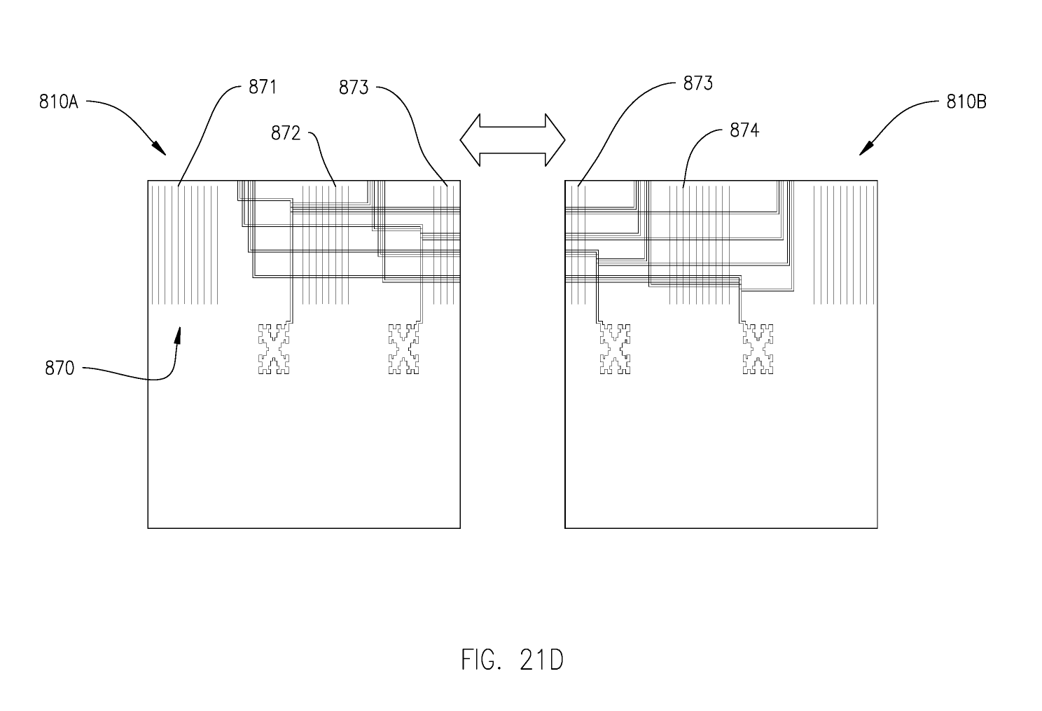

In the following embodiments shown in FIGS. 21A-21D, 22, and 23A-23B, the outward-facing surface of the thermoplastic or resinous surface sheet has been removed to reveal the location of the antennae 50 and the wire leads, including the transceiver connection ends 54, on the inward-facing surface 731b of the thermoplastic or resinous surface sheet.) In the illustrated embodiment shown in FIG. 21A, signals to and from any one of the antennae 50a-50d, can be passed with any one of the four transceiver connection ends 54A, 54B, 54C and 54D. If the shelf 710 is a fabricated smart shelf for a use or service that requires that the length of the shelf 710 be cut in length for a custom installation; for example, cut along any one of the dashed lines 755, then each of the antennae 50 remaining in the resulting section can still be accessed along the respective transceiver connection ends. FIG. 21B shows the shelf 710 cut in half along cut line 755b, to form two separate smart shelves 710A and 710B, each including a respective pair of transceiver connection ends 54 at positions 54A and 54B, and 54C and 54D, respectively.

In a further embodiment of the invention shown in FIGS. 21C and 21D, the smart shelf 810 can have a visible indicia mark, or line, or pattern 870, applied upon and along the length of the thermoplastic or resinous sheet, and positioned laterally in the areas between the adjacent antennae 50 of the plurality of antennae. The patterns 870 indicate the locations along the core layer where a lateral cutting of the core layer would avoid cutting through an antenna 50. The indicia patterns illustrate to the user the safe places along the shelving for cutting laterally in order to avoid cutting through one of the antennae 50. In the illustrated embodiment, the patterns 870 are highlighted or demarcated zones 871, 872, 873, and 874, to provide ranges suitable for cutting the base shelf to a desired length, while preserving the function of the antennae 50. The indicia line, mark or area or pattern can be visible to either the naked or unaided eye, or can be visible only with aided vision, such as the use of infrared-detectable or ultraviolet-detectable compounds that can emit in either the infrared or the ultraviolet wavelengths.

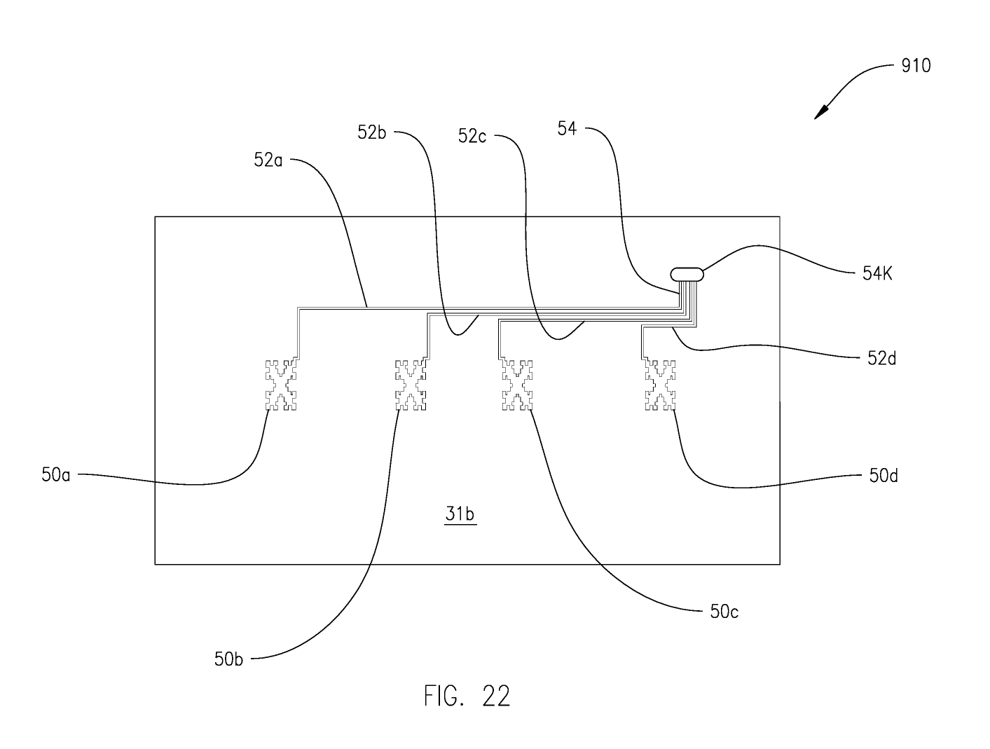

FIG. 22 illustrates a further embodiment of a smart shelf 910 wherein the transceiver connection end 54 in position 54K is formed within an interior portion of the area of the smart shelf, rather than at an end edge, with the leads 52 of each of the antennae 50 extending to the transceiver connection end 54K. The transceiver connection end 54K can be placed at any location within the interior of the periphery of the shelf. This embodiment also permits the inclusion of two or more transceiver connection ends, each being connected to each of the leads of the plurality of antennae 50, as described above.

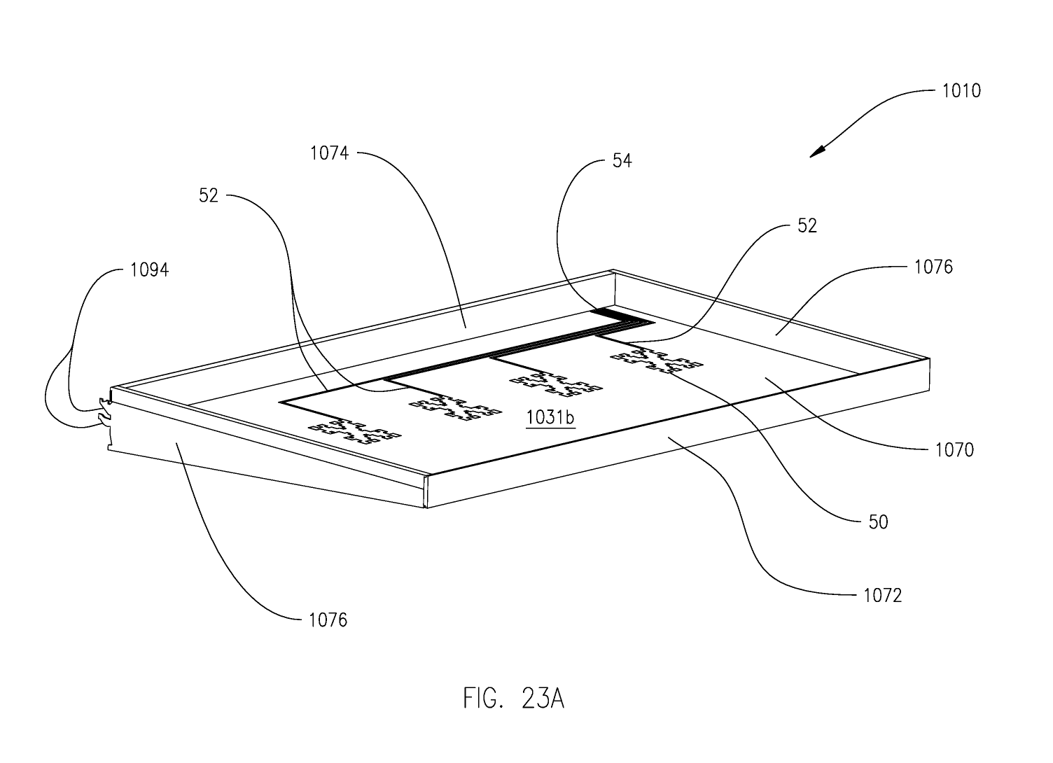

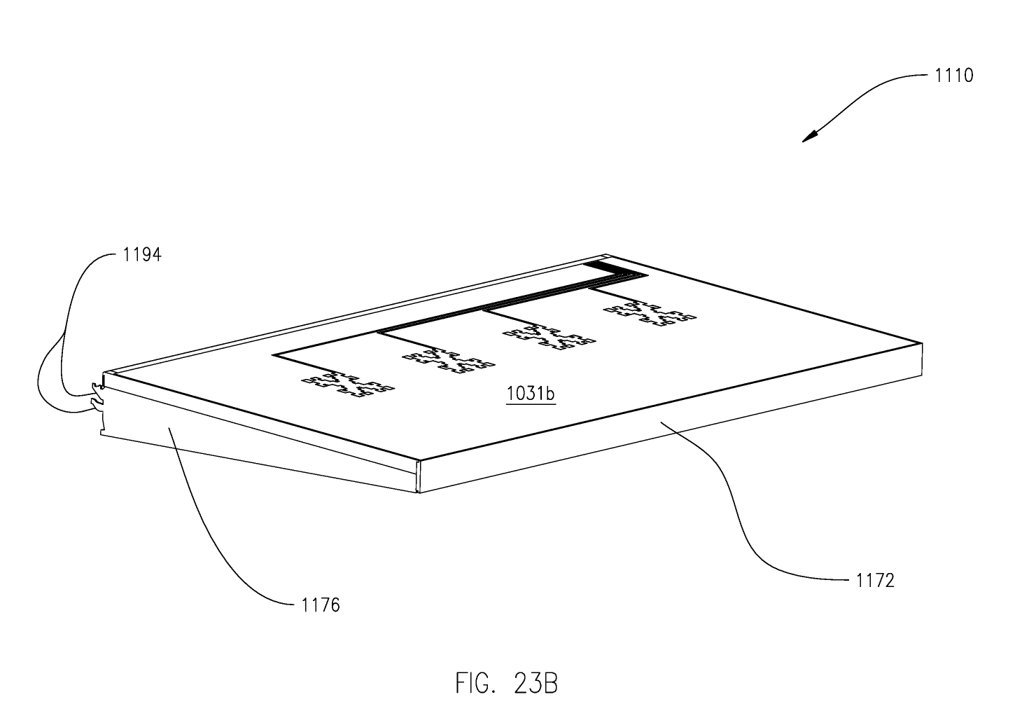

FIG. 23A shows an alternative smart shelf 1010 where the core layer is formed of a thinner structure that permits the core layer to be folded or molded into one or more lateral side walls, to provide a base portion 1070, a front wall 1072, rear wall 1074 and side walls 1076. The side walls 1076 can include rearwardly-extending tabs 1094 for mounting the smart shelf 1010 onto a vertical structure 95, as shown in FIG. 13. FIG. 23B shows a similar alternative smart shelf 1110 having a molded or folded front wall 1172 and side walls 1176. Such thinner, lighter-weight shelves provide RF-reading capability, with a strong and modular structure, and can be used in many facilities including stores, pharmacies, manufacturing plants, offices, and homes.

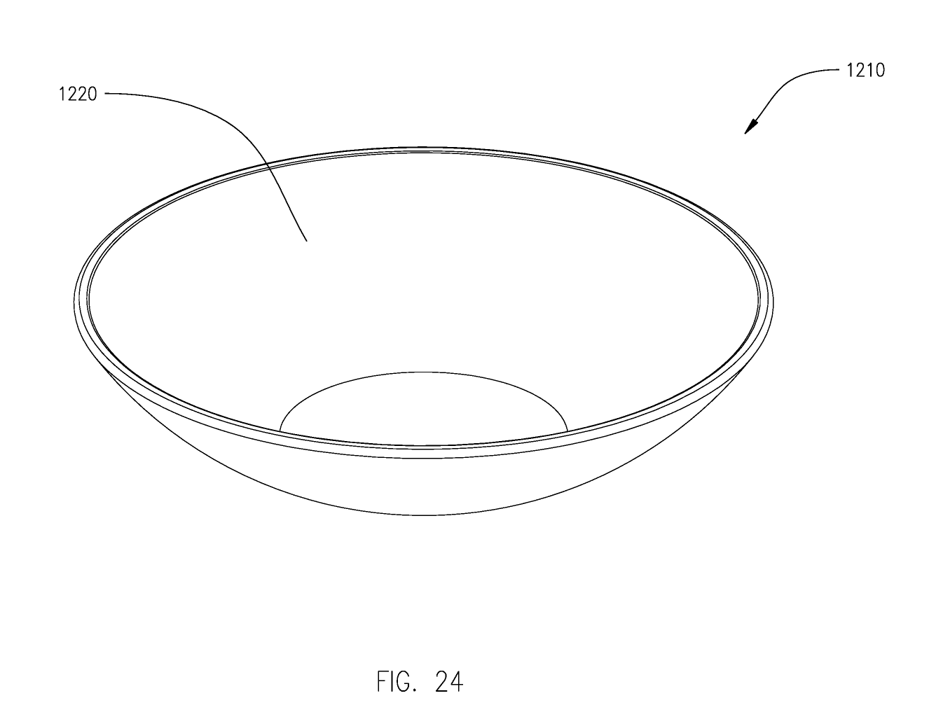

FIG. 24 shows an alternative smart shelf 1210 where the core layer 1220 is formed in a non-planar or three-dimensional (“3D”) shape. In the illustrated embodiment, the shape of the shelf core layer 1220 is bowl shaped. The bowl-shaped shelf can be useful for holding items that might roll off of a planar-surfaced shelf, or for holding a large number of an item. The bowl shape can also be used in an inverted position to allow a pyramidal display of products, for stacking and displaying merchandise, such as produce including without limitation, fragile items like tomatoes and peaches. The non-planar structure of the shelf 1210 can be made by heating a planar-shaped honeycomb-formed core layer, to partially soften the thermoplastic material thereof, and then to mold the heated core layer to the desired shape. In an alternative embodiment, the core layer can include a plurality of stacked, thinner core layers, as shown and described in FIG. 4, where each individually, thinner layer is inherently more flexible and bendable, and the plurality of the stacked layers can slide relatively at their confronting surfaces. Once formed into the desired shape, the shaped stack of thinner core layers can be heated to bond the layers together. In addition, or alternatively, the thermoplastic or resinous top sheet and/or bottom sheet can be positioned on the opposed surfaces of the stack of core layers, and affixed to the shaped stack of core layers to secure the layers into a rigid, durable, and light-weight, RF-ready shelf.

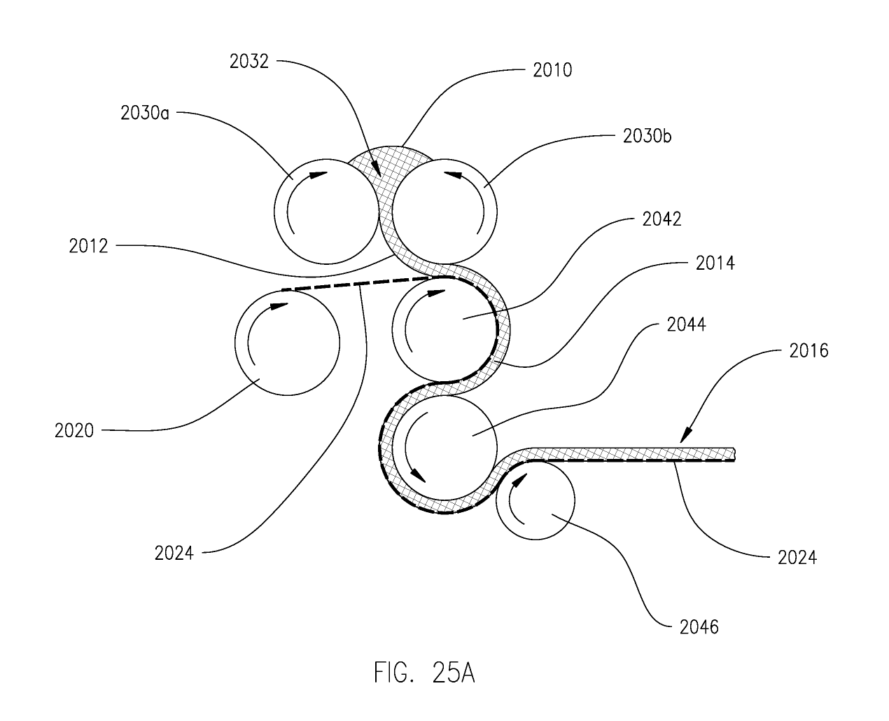

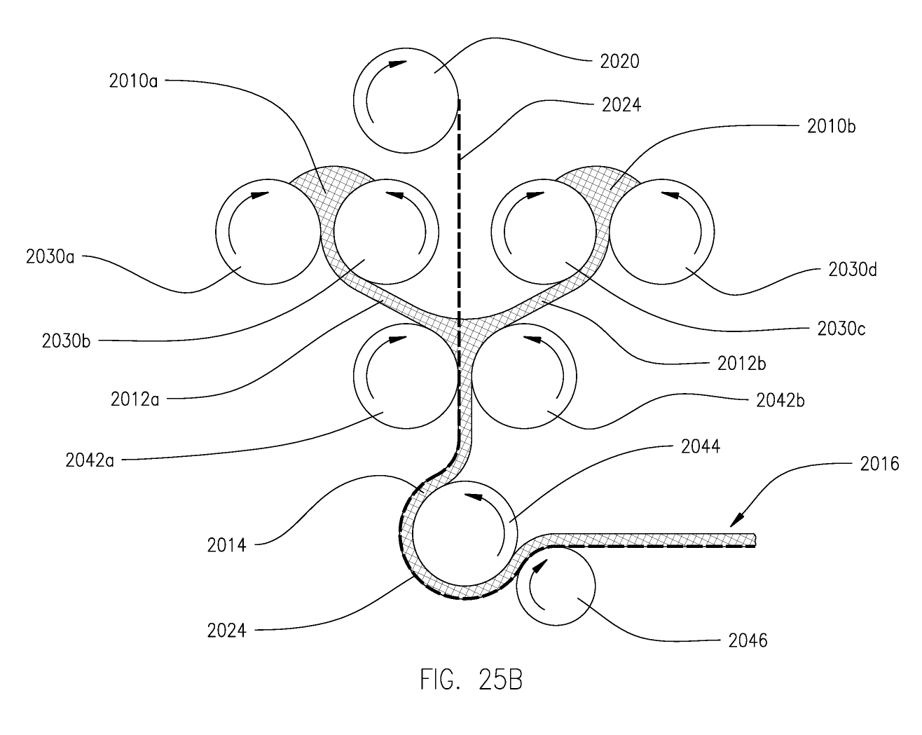

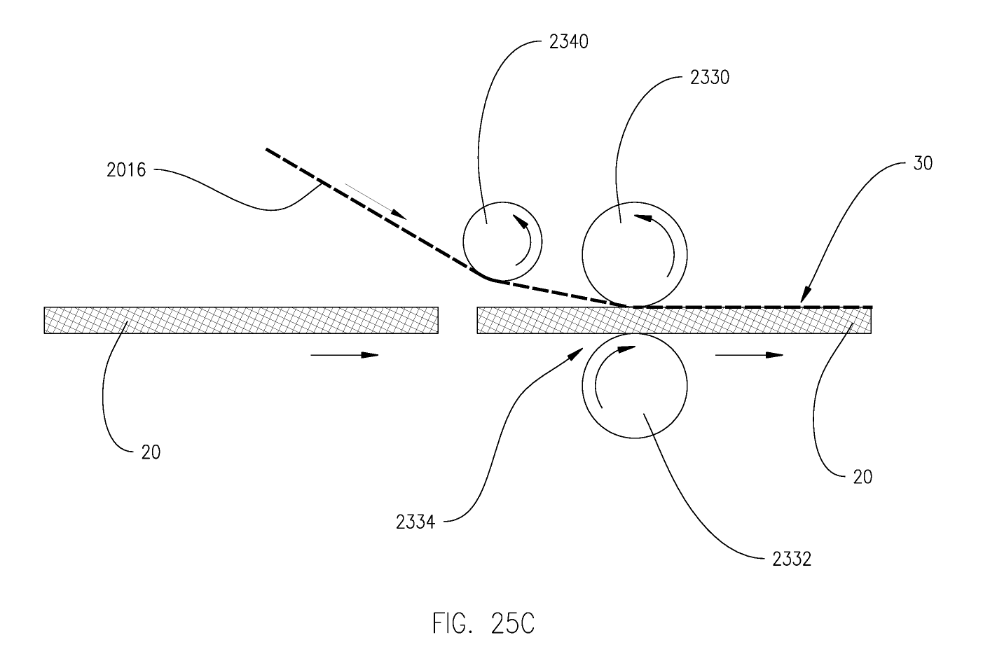

FIGS. 25A and 25B show alternative processes, particularly continuous processes, for making a continuous antennae sheet useful in forming a smart shelf. The sheet comprises a thermoplastic or resinous material and a plurality of antennae affixed along a length of a continuous thermoplastic or resinous material film, and either onto a surface of or embedded within the thermoplastic or resinous material. FIG. 25A illustrates an apparatus and a process including a pair of opposed counter-rotating rollers 2030a and 2030b positioned to form an extrusion nip 2032 there between. A molten thermoplastic or resinous material 2010 is pooled over the rollers 2030a and 2030b, and is extruded through the nip 2032 to form a softened sheet 2012 of the thermoplastic or resinous material. A roller 2020 feeds an antennae film 2024, which includes a film onto which is formed a plurality of RF antennae and their associated leads. The film can be a continuous film or an aperture film. Typically the material of film is a thermoplastic film. The plurality of antennae are positioned along the length of the antennae film 2024 at a regular spacing to allow for a continuous formation of an elongated shelving that can be cut into individual smart shelves. The softened sheet 2012 is passed over a forming roller 2042, while the antennae sheet 2024 is passed under the softened sheet 2012 and over forming roller 2042. The laminate 2014 of the softened sheet 2012 and the antennae film 2024 passes around a further forming roller 2044 and is fed by a guide roller 2046 to a further process, illustrated in FIG. 25C, that laminates the resulting continuous antennae sheet onto a top surface and/or bottom surface of a non-metallic low density core layer.

In an alternative apparatus and a process shown in FIG. 25B, two pools of the molten thermoplastic or resinous material 2010 are extruded through two pairs of opposed counter-rotating rollers 2030a and 2030b, and 2030c and 2030d, to form two softened sheets 2012a and 2012b of the thermoplastic or resinous material. A roller 2020 feeds an antennae fi1m2024, which is laminated between the two softened sheets 2012a and 2012b and passed between opposed forming rollers 2042a and 2042b. The laminate 2014 of the softened sheets 2012a, 2012b and the antennae film 2024 passes around a further forming roller 2044, and the resulting continuous antennae sheet 2018 can be fed by a guide roller 2046 to the further process, such as illustrated in FIG. 25C.

FIG. 25C illustrates a process for laminating a continuous antennae sheet onto the top surface of a portion of a non-metallic low density core layer, which can then be further processed to form the smart shelf structure. A low density core layer can be a series of sheets of a low density core 20 that pass through successively a laminating apparatus comprising a pair of opposed counter-rotating rollers 2330 and 2332 that are positioned to form an compression nip 2334 there between. A continuous antennae sheet 2016 (or 2018) is guided by a roller 2340 to be fed over the top surface of the core sheet 20 and into the nip 2334, and is affixed as a top sheet 30 onto the top surface of the core sheet 20. In an alternative process, the low density core layer can comprise a continuous sheet of low density core, onto which the continuous antennae sheet is laminated continuously, to form a continuous smart shelving structure that can be cut into individual length sheets. An alternative process can also include laminating a second antennae sheet onto the bottom surface of the non-metallic low density core sheet.

The foregoing is considered as illustrative only of the principles of the modular composite smart shelf. Further, since numerous modifications and changes will readily occur to those skilled in the art, it is not desired to limit the invention to the exact construction and operation of the embodiments as shown and discussed in the above FIGS. and description. Accordingly, all suitable modifications and equivalents may be resorted to by one skilled in the art while still falling within the scope of the invention.

1. A modular composite smart shelf that is useful in detecting and reading in real time, via Radio Frequency Identification (RFID), RFID-tagged or labeled articles disposed on or proximate the smart shelf, comprising:
a) a non-metallic low density core layer having opposed top and bottom faces, and an outer perimeter edge;
b) one or more antennae disposed on at least one of the top face and the bottom face of the core layer; and
c) a thermoplastic or resinous surface sheet covering the one or more antennae and secured to at least one of the top face and the bottom face of the core layer.

2. The modular composite smart shelf according to claim 1 wherein the thermoplastic or resinous surface sheet extends along and over the outer perimeter edge of the core layer.

3. The modular composite smart shelf according to claim 1, wherein the one or plurality of antennae are affixed to or embedded within the surface sheet.

4. The modular composite smart shelf according to claim 3, wherein the core layer comprises a three-dimensional structure including a matrix of thermoplastic elements, and the top face of the core layer has a non-planar surface.

5. The modular composite smart shelf according to claim 4, wherein the thermoplastic or resinous surface sheet is secured to the upper non-planar surface of the core layer.

6. The modular composite smart shelf according to claim 5, wherein the shelf further comprises a molded frame secured to a portion of the outer perimeter edge of the core layer.

7. The modular composite smart shelf according to claim 6, wherein the molded frame includes:
a) an elongated rear molded frame member affixed to a face of a rear edge of the core layer, having a cavity with a rear-facing opening along a length of the elongated rear molded frame member;
b) an elongated front molded frame member affixed to a face of a front edge of the core layer; and
c) opposed side molded frame members affixed to a face of a pair of opposed side edges of the core layer, each said side molded frame member connecting the rear molded frame member to the front molded frame member.

8. The modular composite smart shelf according to claim 6, wherein the shelf further comprises a radio frequency (RF) transceiver in electrical communication with the one or more antennae secured within a cavity of a rear molded frame member.

9. The modular composite smart shelf according to claim 8, wherein the shelf further comprises a power and communications connector secured within the cavity of the rear molded frame member, and connected in electronic communication with the RF transceiver.

10. The modular composite smart shelf according to claim 7, wherein the front molded frame member is further defined by a top surface and having a separate video display panel mounted on the front edge of the shelf, thereby rendering the shelf operable to be electronically plugged, via the power and communications connector, into a power and signal receptor of a shelving structure comprising a plurality of shelves and immediately function to read radio frequency identification (RFID) tagged articles on the shelf.

11. The modular composite smart shelf according to claim 10, wherein the power and communications connector is additionally connected in electronic communication with the front video display panel.

12. The modular composite smart shelf according to claim 8, wherein the power and communications connector includes a plurality of power and communication blades rearwardly extending through the rear-facing opening of the rear molded frame member, configured to engage a plurality of power and communication slots in an upright support member of the shelving structure to which the smart shelf may be attached.

13. (canceled)

14. The modular composite smart shelf according to claim 8, wherein the shelf further comprises a closure covering a portion of the rear-facing opening of the rear molded frame member.

15.-21. (canceled)

22. The modular composite smart shelf according to claim 8, wherein the rear molded frame member contains one or more electronic components for communication with or between the RF transceiver, the front video display panel, and with a power or communication electronic device in the shelving structure.

23.-24. (canceled)

25. The modular composite smart shelf according to claim 1, wherein the shelf further comprises:
a) a plurality of antennae disposed on at least one of the top face and the bottom face of the core layer, each antenna having a pair of leads;
b) a plurality of transceiver connection ends disposed in or extending from a peripheral edge of the shelf, each of the transceiver connection ends disposed laterally from one of the plurality of antennae, where a pair of leads of each of the plurality of antennae connect to each of the plurality of transceiver connection ends; and
c) a visible indicia mark or pattern applied upon and along the length of the thermoplastic or resinous sheet, positioned longitudinally between the adjacent antennae of the plurality of antennae, to indicate the location along the core layer where a cutting laterally of the shelf avoids cutting through an antenna.

26. The modular composite smart shelf according to claim 25, wherein the indicia marks or patterns are visible to either the naked or aided eye.

27. The modular composite smart shelf according to claim 1, wherein the shelf includes a plurality of spaced-apart apertures through the core layer and the thermoplastic or resinous surface sheet, to provide ventilation through the shelf, wherein the plurality of spaced-apart apertures pass through the core layer along paths that do not intersect and interrupt a lead of the one or more antennae.

28.-31. (canceled)

32. The modular composite smart shelf according to claim 1, wherein the core layer includes a plurality of layers of the three-dimensional structure.

33. The modular composite smart shelf according to claim 1, wherein the core layer includes a reinforced cavity within the structure of the core layer for insertion and securing of an electronic component.

34.-35. (canceled)

36. The modular composite smart shelf according to claim 1, wherein the core layer comprises a three-dimensional structure including a matrix of thermoplastic elements, having a specific density of up to about 0.5.

37.-41. (Canceled)
